(19) United States
(12) Patent Application Publication
(10) Pub. No.: US 2010/0106608 A1
(43) Pub. Date: Apr. 29, 2010

(54) Method for Completing and Storing an Electronic Rental Agreement

(76) Inventors: Nereida Maria Menendez, Ft. Lauderdale, FL (US); Paula S. Williams, Bal Harbour, FL (US); Michael J. Manis, Boca Raton, FL (US)

Correspondence Address: THOMPSON COBURN LLP, ONE US BANK PLAZA, SUITE 3500, ST LOUIS, MO, 63101, US

(21) Appl. No.: 12/650,040

(22) Filed: Dec. 30, 2009

Related U.S. Application Data
(62) Division of application No. 09/698,502, filed on Oct. 27, 2000.

(51) Int. Cl. G06Q 30/00; G06Q 40/00; G06Q 20/00; G06Q 10/00; G06F 15/16; G06F 17/00; G06F 3/048; G06Q 50/00

(52) U.S. Cl. 705/17; 705/4; 705/27; 705/30; 705/307; 709/206; 715/226; 715/760

(57) ABSTRACT

Methods and systems are disclosed for creating and storing an electronic rental contract for a rental vehicle from a rental car company to permit a user to bypass a rental counter of a car rental facility when creating the electronic rental contract. A rental vehicle reservation can be created for a user, and then a rental proposal can be created and displayed based upon the reservation. Upon acceptance of the rental proposal by the user, the electronic rental contract is created. A kiosk may be used to form the electric rental contract.

### CROSS-REFERENCE AND PRIORITY CLAIM TO RELATED APPLICATION

This application is a divisional of U.S. application Ser. No. 09/698,502, filed Oct. 27, 2000, the entire disclosure of which is incorporated herein by reference.

This application is related to commonly assigned, copending U.S. patent application Ser. No. 09/556,153, filed Apr. 21, 2000, entitled “Reservation Entry Method and System” and published as U.S. Patent Publication No. 2003-0149600; 09/564,911, filed May 4, 2000, entitled “System And Method For Evaluating Items Or Services For Possible Reservation”; 09/698,491, filed Oct. 27, 2000, entitled “System and Method for Completing a Rental Agreement Online”; and 09/698,552, filed Oct. 27, 2000, entitled “Method for Completing a Rental Agreement Online and Bypassing a Rental Counter”; and 11/692,308, filed Mar. 28, 2007, entitled “System and Method for Completing a Rental Agreement Online” and published as U.S. Patent Application Publication No. 2007-0198311. This application is also related to commonly-assigned, copending U.S. patent application Ser. No. ______, filed this same day, entitled “Method for Completing and Storing an Electronic Rental Agreement” (identified as Thompson Coburn Docket No. 51017-84536).

### BACKGROUND OF THE INVENTION

1. Field of the Invention

The present invention relates to a method for completing a rental agreement and, more particularly, to a method for completing and storing an electronic rental agreement for an item or service, such as a vehicle rental service.

2. Background Information

The Internet comprises a vast number of computers and computer networks that are interconnected through communication links. The interconnected computers exchange information using various services, such as electronic mail (i.e., e-mail), and the World Wide Web (“WWW”). The WWW service allows a server computer system (e.g., a web server, a web site) to send graphical web pages of information to a remote client computer system. The remote client computer system can then display the web pages. Each resource (e.g., computer, web page) of the WWW is uniquely identifiable by a Uniform Resource Locator (“URL”). To view a specific web page, a client computer system specifies the URL for that web page in a request (e.g., a HyperText Transfer Protocol (“HTTP”) request). The request is forwarded to the web server that supports that web page. When that web server receives the request, it sends that web page to the client computer system. When the client computer system receives that web page, it typically displays the web page using a browser. A browser is a special-purpose application program that effects the requesting of web pages and the displaying of web pages.

Currently, web pages are typically defined using HyperText Markup Language (“HTML”). HTML provides a standard set of tags that define how a web page is to be displayed. When a user indicates to the browser to display a web page, the browser sends a request to the server computer system to transfer to the client computer system an HTML document that defines the web page. When the requested HTML document is received by the client computer system, the browser displays the web page as defined by the HTML document. The HTML document contains various tags that control the displaying of text, graphics, controls, and other features. The HTML document may contain URLs of other web pages available on that server computer system or other server computer systems.

The World Wide Web is especially conducive to conducting electronic commerce (i.e., e-commerce). Many web servers have been developed through which vendors can advertise and sell products or enter reservations for items or services, such a vehicle rentals.

A typical evaluation process for a vehicle rental reservation on a web site on the Internet includes the repetition (for a desired number of different vehicles) of seven steps across a plurality of different web pages. The seven steps, which are employed to determine the availability of one vehicle, include: (1) entering a user's personal information; (2) entering the pick-up date, location and time of the desired rental; (3) entering the drop-off date and time (and optionally the drop-off location) for the rental; (4) selecting a vehicle type; (5) entering other applicable information and clicking to request the rental availability, rates and reservation information for the selected vehicle type; (6) displaying the rental availability, rates and reservation information for the user; and (7) displaying the user-entered information. After these steps, the user may click to reserve the particular vehicle.

It is known to provide a master rental proposal and to accept such proposal, in handwriting, in order to provide a master rental agreement, such as a car rental club agreement.

It is also known to online-modify a pre-existing master rental agreement.

It is further known to online-enter a reservation based upon a pre-existing master rental agreement, in order to bypass a rental counter at a rental facility.

Known vehicle rental agreements must be signed in handwriting, with selected or declined options, such as, for example, CDW, requiring initials in handwriting. In turn, the signed and initialed document may be scanned and stored on a suitable electronic media (e.g., a CD) for possible future reference.

There is room for improvement in systems and methods for online reservations.

### SUMMARY OF THE INVENTION

Known conventional reservation methods do not permit a user to complete and store an electronic rental agreement for a vehicle without employing a pre-existing master rental agreement. Furthermore, such methods do not permit a user to complete and store an electronic rental agreement with rental-related information that is different from that which is contained in the master rental agreement. In such circumstances, the user, such as a business traveler or a person on vacation, must complete a handwritten rental agreement at a rental counter, thereby wasting business or vacation time at the counter.

The present method enters: (a) rental-related information without employing a master rental agreement, or (b) at least some of the rental-related information from a master rental agreement and allows modification of the information from the master rental agreement for rental of an item or service without modifying the master rental agreement; electronically accepts a rental proposal; and stores an electronic rental agreement based upon the accepted rental proposal.

In accordance with the present invention, a method for completing and storing an electronic rental agreement comprises: entering reservation-related information and rental-related information for an item or service, the entering step entering: (a) the rental-related information without employing a master rental agreement, or (b) at least some of the rental-related information from a master rental agreement and allowing modification of the information from the master rental agreement for rental of the item or service without modifying the master rental agreement; providing a reservation for the item or service based at least in part upon the reservation-related information; creating and displaying a rental proposal based upon the reservation and the rental-related information; electronically accepting the rental proposal; and storing the electronic rental agreement based upon the accepted rental proposal.

As a refinement, a message is sent to a database system responsive to the accepting step to indicate that a user has accepted the rental proposal. Also, a unique transaction is stored in the database system for the accepted rental proposal. Further, a flag is stored along with the unique transaction in the database system to indicate that the accepted rental proposal is electronically signed. Preferably, the stored flag is employed to enable allocation of the item or service at a kiosk.

As a further refinement, a plurality of rental options are employed in the rental-related information; at least some of the rental options are accepted or declined; and a plurality of flags corresponding to the rental options are stored to signify the rental options that a user has accepted or declined. Preferably, the stored flags are retrieved; and it is determined whether the user accepted or declined the rental options based upon the retrieved stored flags.

### BRIEF DESCRIPTION OF THE DRAWINGS

A full understanding of the invention can be gained from the following description of the preferred embodiments when read in conjunction with the accompanying drawings in which:

FIG. 1 is a block diagram of a rental/reservation process in accordance with an embodiment of the present invention.

FIG. 2 is a block diagram of a client/server system in accordance with another embodiment of the present invention.

FIG. 3 is a block diagram of a vehicle reservation and rental process in accordance with another embodiment of the present invention.

FIG. 4 is a block diagram of a client/server system in accordance with another embodiment of the present invention.

FIG. 5 is a block diagram of a vehicle reservation and rental process in accordance with another embodiment of the present invention.

FIG. 6A is a block diagram showing a link from a home web page to a second web page, which presents an overview of exemplary steps, in accordance with an embodiment of the present invention.

FIG. 6B is a “tell us about your trip” web page as displayed by the client system of FIG. 2 after the display of the second web page of FIG. 6A.

FIG. 6C is a “select a vehicle” web page (after a calculation) as displayed by the client system of FIG. 2.

FIGS. 6D1 and 6D2 depict a “select rental options and calculate total” web page as displayed by the client system of FIG. 2 after the display of the web page of FIG. 6C.

FIGS. 6E1 and 6E2 depict a “reservation confirmation” web page as displayed by the client system of FIG. 2.

FIGS. 6F1 and 6F2 depict a “tell us about yourself” web page as displayed by the client system of FIG. 2.

FIG. 6G is an “additional driver” web page as displayed by the client system of FIG. 2 after the display of the web page of FIGS. 6F1 and 6F2.

FIG. 6H is a “your past rentals” web page as displayed by the client system of FIG. 2 after the display of the web pages of FIGS. 6F1 and 6F2 or 6G.

FIG. 6I is an “optional equipment” web page as displayed by the client system of FIG. 2 after the display of the web page of FIG. 6H.

FIGS. 6J1-6J3 depict a “review your rental” web page as displayed by the client system of FIG. 2 after the display of the web page of FIG. 6I.

FIG. 6K is a “terms and conditions” web page as displayed by the client system of FIG. 2 after the display of the web page of FIGS. 6J1-6J3.

FIGS. 6L1-6L3 depict a “rental confirmation” web page as displayed by the client system of FIG. 2 after the display of the web page of FIG. 6K.

FIGS. 7A-7C2 are flow diagrams of the system of FIG. 2.

FIG. 8 is a block diagram of a process of storing a unique reservation and rental transaction in accordance with an embodiment of the invention.

FIG. 9 is a block diagram of a process of storing a unique reservation and rental transaction in accordance with another embodiment of the invention.

### DESCRIPTION OF THE PREFERRED EMBODIMENTS

As employed herein, the term “vehicle” shall expressly include, but not be limited to, any new or used vehicle having pneumatic tires, such as, for example, land-based vehicles, automobiles, cars, trucks, sport utility vehicles (SUVs), vans, motorcycles, mopeds, campers, trailers, and bicycles.

As employed herein, the term “item” shall expressly include, but not be limited, to any product or good which is available for reservation, such as, for example, a vehicle.

As employed herein, the term “service” shall expressly include, but not be limited, to any service which is available for reservation, such as, for example, a vehicle rental service.

As employed herein, the term “communication network” shall expressly include, but not be limited to, any local area network (LAN), wide area network (WAN), intranet, extranet, wireless communication system, global communication network, and the Internet.

As employed herein, the term “personal information” shall expressly include, but not be limited to, information pertaining to a natural person, firm, corporation, association, group or organization.

As employed herein, the term “rental facility” shall expressly include, but not be limited to, a facility, which provides rentals of items or services, such as, for example, a car rental facility of a car rental vendor at or near an airport (e.g., an airport in Miami, Fla.; an airport in Los Angeles Calif.; an airport in Boston, Mass.).

As employed herein, the term “rental counter” shall expressly include, but not be limited to, a rental counter, which its typically staffed by one or more persons, at or near a rental facility.

As employed herein, the term “kiosk” shall expressly include, but not be limited to, a rental station, which its typically not staffed by any persons, at a rental facility.

As employed herein, the term “vehicle rental lot” shall expressly include, but not be limited to, a parking lot, building or area for rental vehicles at a rental facility.

As employed herein, the term “exit gate” shall expressly include, but not be limited to, an exit, which its typically staffed by one or more persons, from a vehicle rental lot at a rental facility.

As employed herein, the term “HTML” shall expressly include, but not be limited, to HTML, dHTML (dynamic HTML), and other suitable technologies to produce a web page.

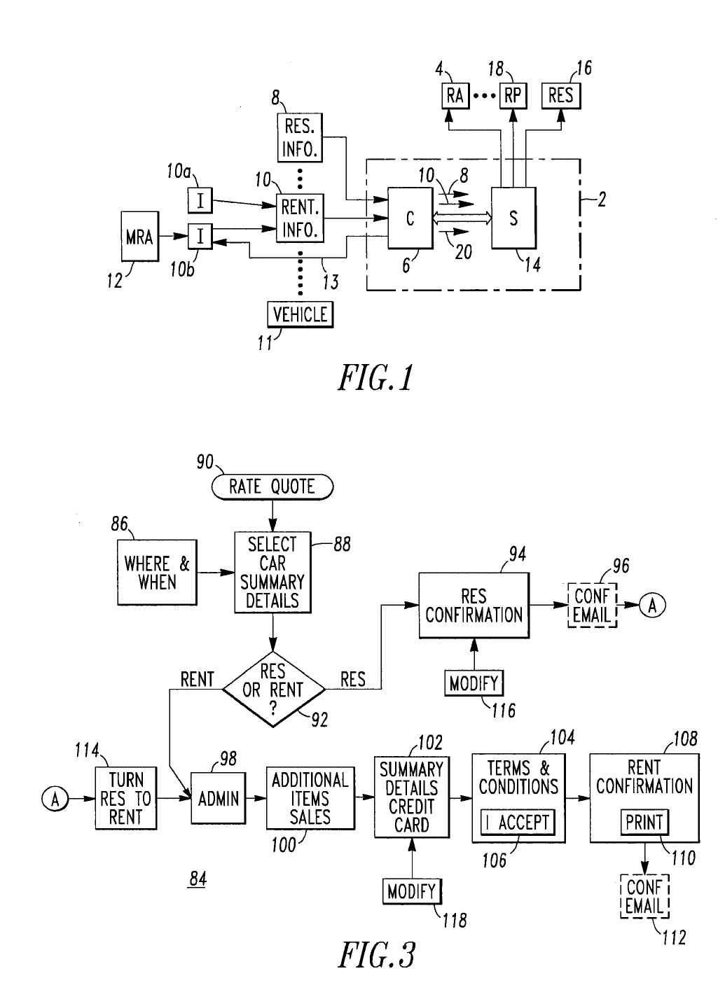

FIG. 1 illustrates a process, which in the exemplary embodiment employs a client/server system 2, to complete a rental agreement (RA) 4 online. At a client system (C) 6, reservation-related information (RES. INFO.) 8 and rental-related information (RENT. INFO.) 10 are entered for an item or service, such as a vehicle 11 or a vehicle rental service. The rental-related information 10 is entered in one of two manners: (a) information (I) 10a is entered without employing a master rental agreement, or (b) at least some of rental-related information (I) 10b is entered from a master rental agreement (MRA) 12, with the entry allowing modification 13 of such information 10b for rental of the vehicle 11 without modifying the master rental agreement 12.

In turn, at a server system (S) 14, a reservation (RES) 16 for the vehicle 11 is provided based at least in part upon the reservation-related information 8. Such reservation-related information 8 may include: (1) only information which is related to a reservation; and/or (2) information which is related to a reservation and a rental. A rental proposal (RP) 18 is created and displayed based upon the reservation 16 and the rental-related information 10. The rental proposal 18 is accepted online at 20. Finally, the rental agreement 4, which is based upon the accepted rental proposal 18, is displayed.

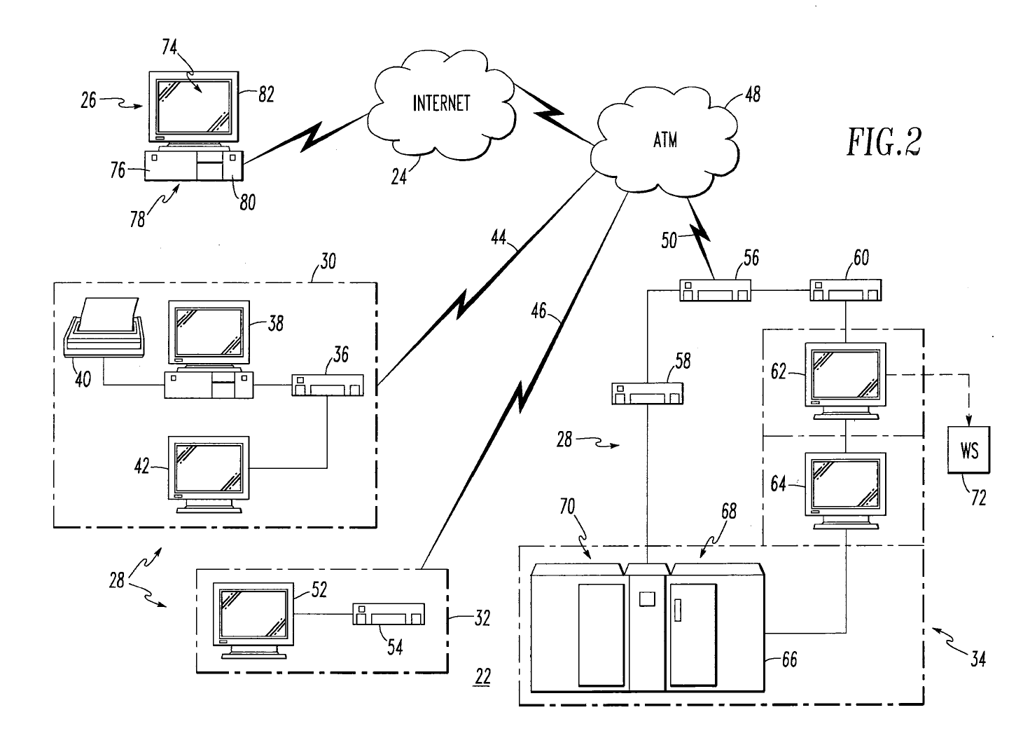

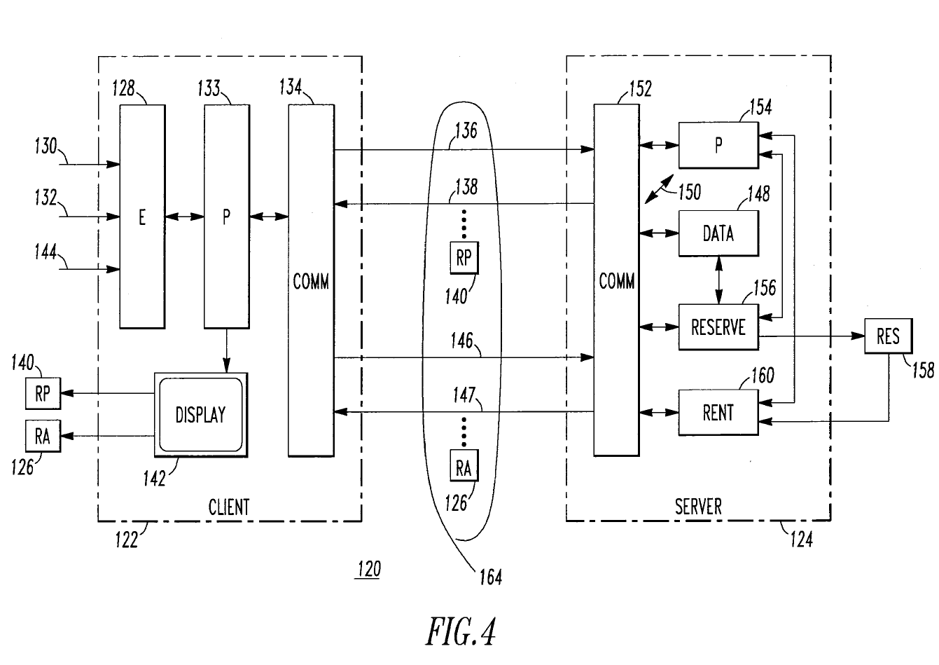

FIG. 2 illustrates an exemplary client/server system 22 which employs a suitable communication sub-system in the form of a global communication network, such as the Internet 24, between a client system 26, such as a personal computer (PC), for a consumer and a server system 28 for a rental company. The exemplary server system 28 includes a first private network 30 at a rental facility, a second private network 32 at a reservation site, and a server sub-system 34. The first private network 30 includes a router 36, a display 38 and a printer 40 at a kiosk, and one or more terminals 42 at a rental counter. The first private network 30 and the second private network 32 employ respective frame relay protocols 44 and 46 for communication with an asynchronous transfer mode (ATM) gateway 48 of the communication sub-system. The gateway 48, in turn, employs an ATM protocol 50 for communication with the server sub-system 34. The second private network 32 includes one or more terminals 52 and a router 54.

The server sub-system 34 includes an ATM switch 56, a router 58, a firewall 60, a processor component such as the exemplary web server 62 on the public side of the sub-system, a data storage component such as the exemplary database server 64 on the DMZ side of the sub-system, and a mainframe computer 66 on the private side of the sub-system. The server sub-system 34 further includes a reservation component such as the exemplary reservation system 68 running on the mainframe computer 66, and a rental component such as the exemplary rental system 70 which also runs on the mainframe computer. The web server 62 provides a web site (WS) 72 for access by consumers such as a consumer (e.g., user, customer) at the client system 26.

The client system 26 includes a display component such as the exemplary browser 74 for displaying portions of the web site 72, a data entry component 76, a processor component 78, and a communication component 80, such as a modem. With reference to FIG. 1, under control of the client system 26 of FIG. 2, a consumer enters the information 8,10 pertaining to reservation/rental of an item or service, such as the exemplary vehicle 11. Alternatively, the service may be, for example, a vehicle rental service. The components 76,78,80 cooperate to send first information as reservation-related information 8 to the web site 72, to send second information as rental-related information 10 to the web site, and to receive the rental proposal 18 from the web site. Preferably, the display component 74 displays the received rental proposal 18.

The communication sub-system 80 employs the ATM protocol 50. The ATM switch 56 and the firewall 60 form a communication component of the server sub-system 34. The client system 26 communicates with the web server 62 with the ATM protocol 50 through the ATM switch 56 and the firewall 60.

Continuing to refer to FIGS. 1 and 2, one or both of the printer 40 and the display 38 at the kiosk of the rental facility are employed for displaying the rental agreement 4. Also, one or both of the client system 26 and the display 38 at the kiosk of the rental facility may display the rental proposal 18.

The terminals 42 at the rental counter of the rental facility may also be employed for displaying the rental agreement 4. Both the frame relay protocol 44 and the ATM protocol 50 are employed between the kiosk and the rental counter of the rental facility and the server sub-system 34. However, in the exemplary embodiment, that communication is through the ATM switch 56 and the router 58.

In a preferred embodiment, the rental proposal 18 of FIG. 1 is accepted at the client system 26 of FIG. 2. Alternatively, a consumer may also accept the rental proposal 18 at the display 38 at the kiosk of the rental facility.

The web server 62 launches various requests and creates the final display of HTML pages for the exemplary client system 26. While reference has been made to the exemplary PC 26 and server 62, other suitable processors such as, for example, PDAs, other wireless devices, network- or web-PCs, microcomputers, microprocessors, workstations, minicomputers or mainframe computers may be employed.

The web server 62 receives HTTP requests from the PC 26 to access web pages of the web site 72, as identified by URLs. In response, the web server 62 provides HTML documents for display of the web pages by the client system 26.

The server sub-system 34 and client system 26 interact by exchanging information via a communication network, which may include transmission over the Internet 24, although the methods disclosed herein may be used in various environments other than the Internet. For example, an electronic mail environment may be employed. Also, various communication channels may be used such as, for example, a local area network, wide area network, or point-to-point dial up connection.

In the exemplary embodiment, communication is provided over a communication network, such as the Internet 24 using the World Wide Web (WWW). The system 22 includes one or more exemplary client systems, such as 26, and the server sub-system 34. The server sub-system 34 and the PC 26 are connected to the WWW by one or more Internet Service providers (ISPs) (not shown), in order that the PC 26 provides access to the WWW and, thus, access to web server 62 of the server sub-system 34, in order to display the web pages.

Any suitable server system may be employed which includes one or more servers or any combination of hardware or software for processing reservations and rentals. The servers 62,64 of the exemplary server sub-system 34 function, for example, on a Windows NT platform with a Microsoft IIS server software license, although the invention is applicable to a wide range of server platforms.

Furthermore, a suitable client system may comprise any combination of hardware or software that can interact with the server sub-system 34. These systems may include television-based systems or various other consumer products through which reservation/rental requests may be entered. The exemplary PC 26 employs, for example, the Microsoft Internet Explorer 4.0 or 5.0 browser running on Windows 95 or 98, although the invention is applicable to any suitable computer, browser, operating system, data entry device, and communication device.

The exemplary PC 26 includes a display 82 for the web pages, which displays information regarding the vehicle 11 of FIG. 1. The PC 26 also includes the exemplary data entry component 76, such as a keyboard (not shown), which the user employs in cooperation with the display 82, and a mouse (not shown) having one or more buttons for control of the data entry and display functions. The PC 26 and browser 74, in turn, receive and process the HTML documents from the web server 62 for display of the web pages on the display 82. The user employs the exemplary data entry component 76 to enter information pertaining to the vehicle 11 on the web pages. The PC 26, in cooperation with the ISP, and responsive to user requests, sends information to the server sub-system 34.

One or more client systems 26 and the server sub-system 34 form the client/server computer system 22 in which a global communication network, such as the Internet 24, provides a communication sub-system therebetween. The exemplary WWW sends requests to the server sub-system 34 and responsive information therefrom. Preferably, the server system 28 and the client system 26 employ Secure Socket Layer (SSL) security or another suitable security protocol (e.g., SET, PKI) in order to enhance the security of the user's reservation/rental information as communicated over the Internet 24.

The exemplary system 22 provides reservations/rentals for vehicles, such as cars, although the invention is applicable to a wide range of items or services (e.g., without limitation, equipment leasing, such as, for example, leasing of aircraft or heavy equipment; procurement processes).

FIG. 3 illustrates a block diagram of a vehicle reservation and rental process 84 in accordance with another embodiment of the invention. In the exemplary embodiment, a customer logs onto the exemplary web site 72 of FIG. 2, enters reservation-related information, and enters additional rental-related information, thereby completing enough information to finish a rental request. Then, at the client system 26, the customer clicks on an “I accept” button on a web page, which, in turn, is stored by the mainframe 66 as an electronic signature.

The exemplary web site 72 of FIG. 2 permits a customer to enter reservation-related information on the web site and complete the reservation. The customer enters the web server 62 through the ATM switch 56 and firewall 60 in order to access the web service for the corresponding domain name. In turn, the web server 62 initiates a conventional request for a reservation through the database server 64 to the reservation system 68 on the mainframe 66. Furthermore, in accordance with the present invention, the web server 62 allows the additional entry of rental-related information for the rental system 70 on the mainframe 66.

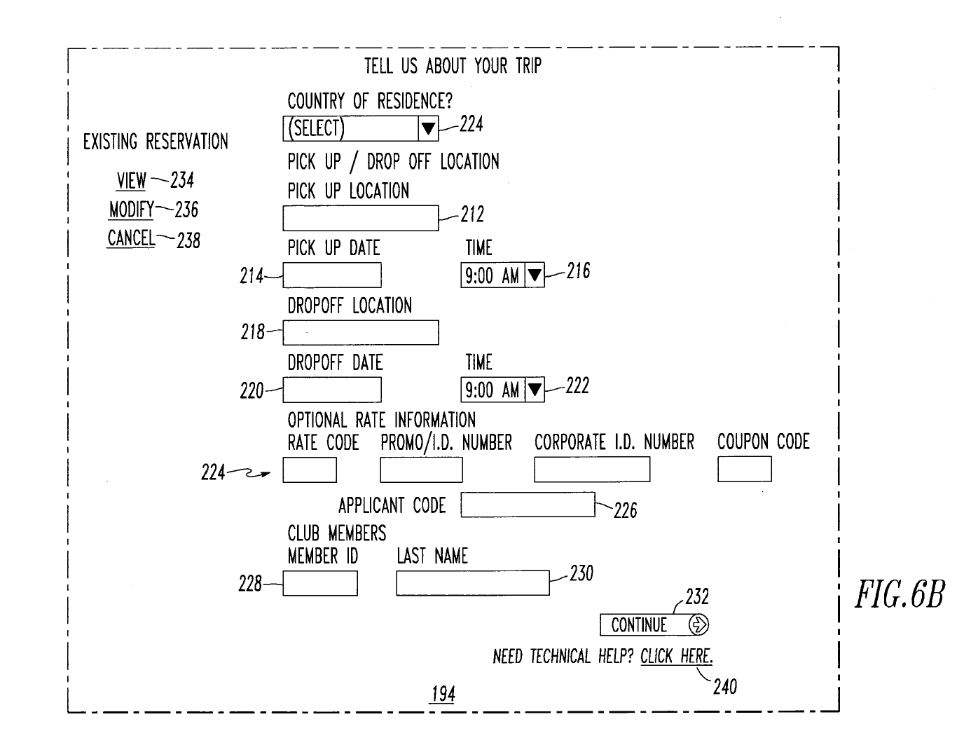

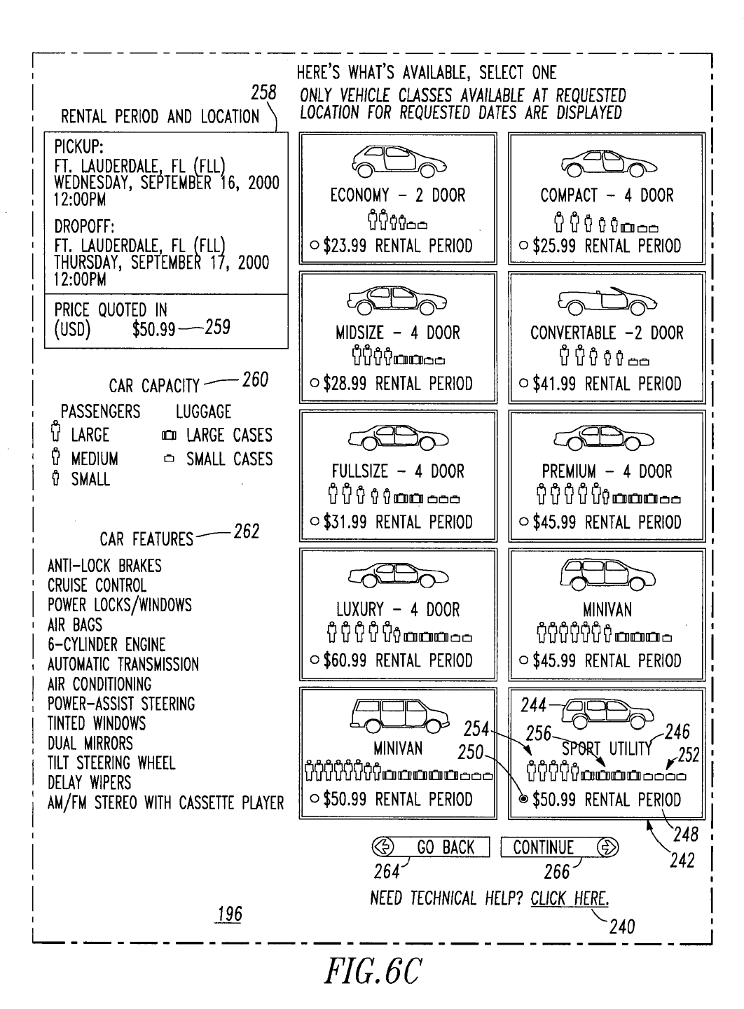

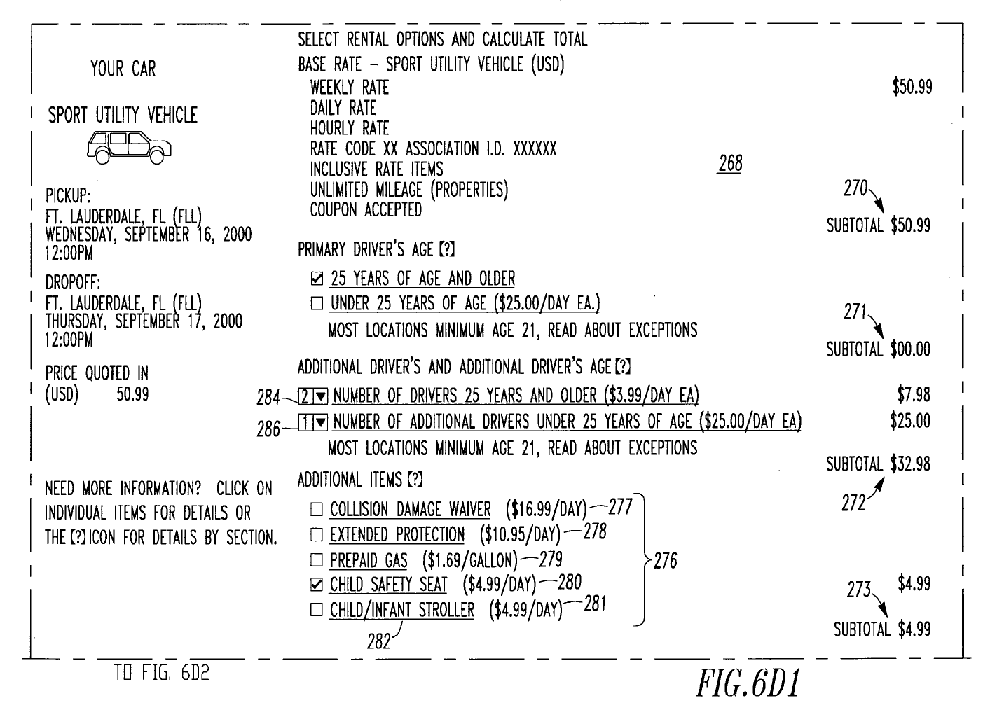

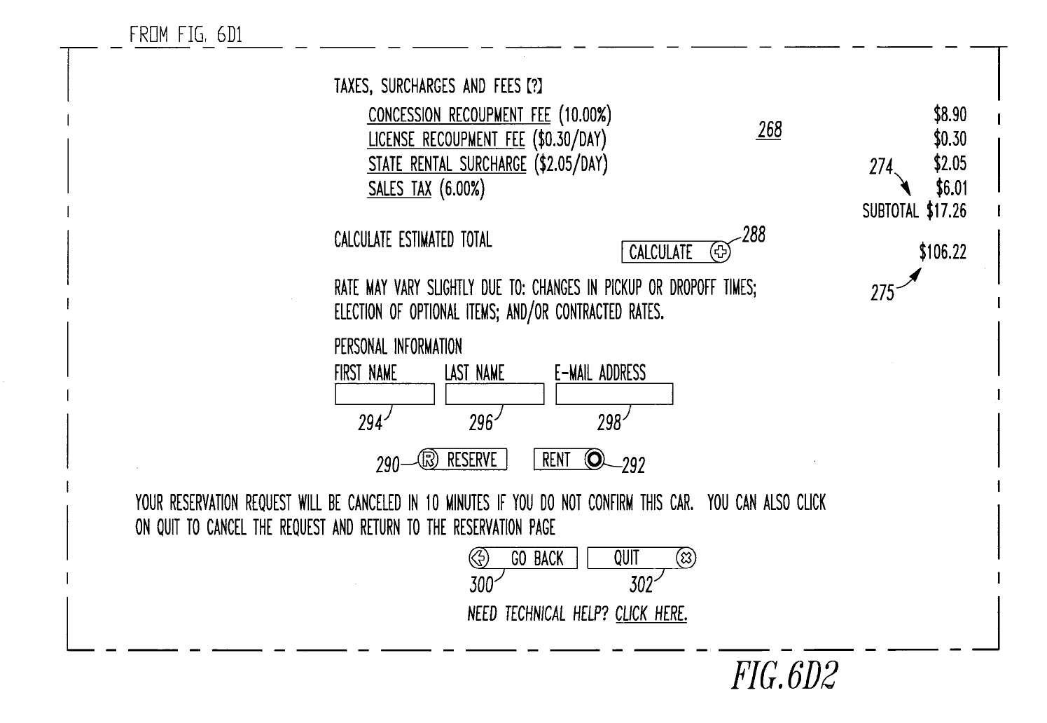

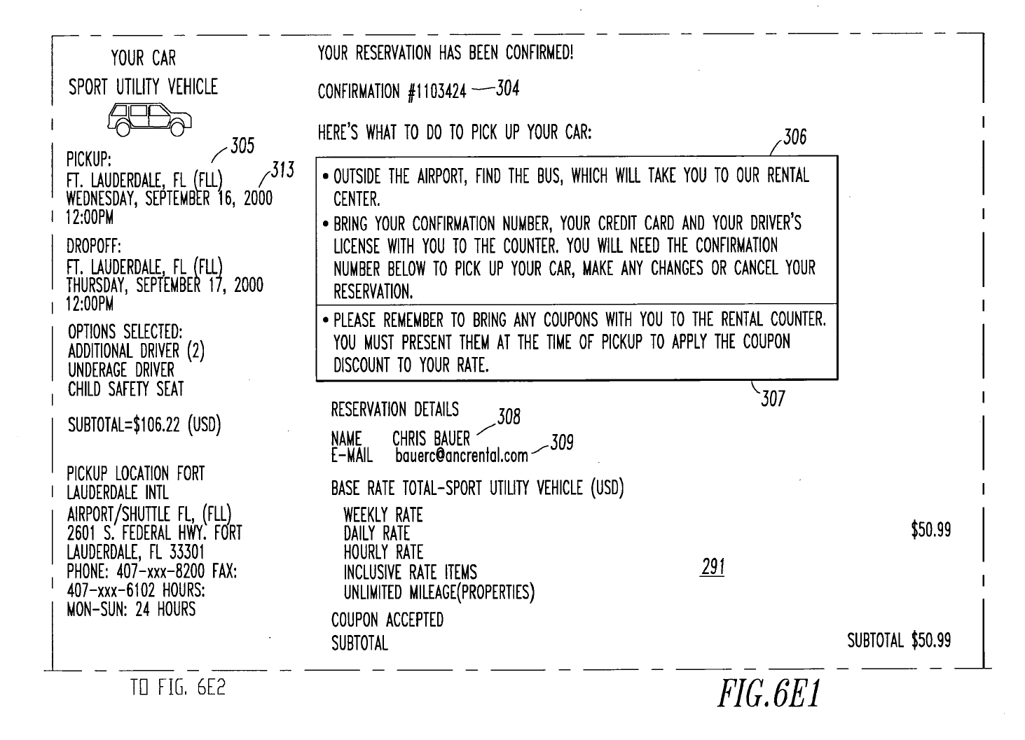

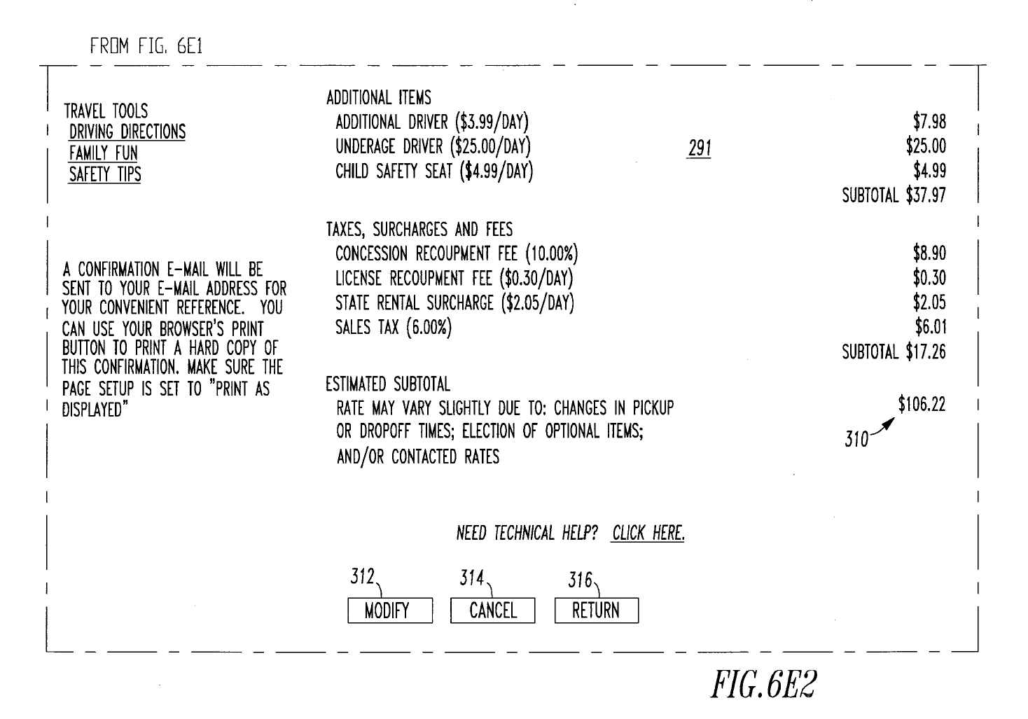

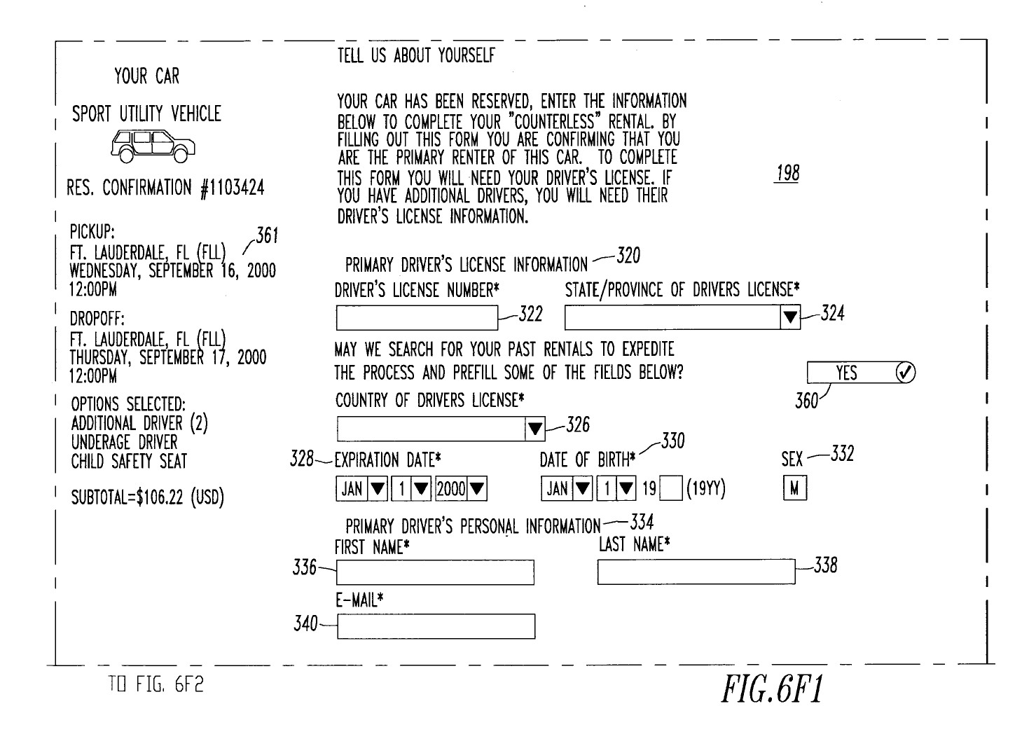

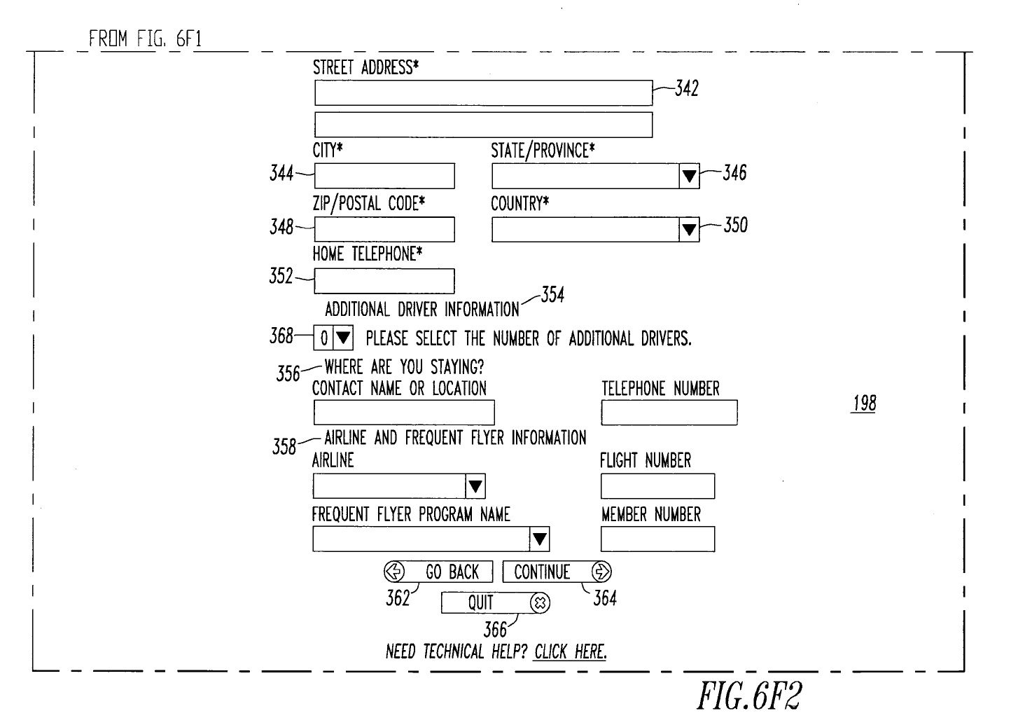

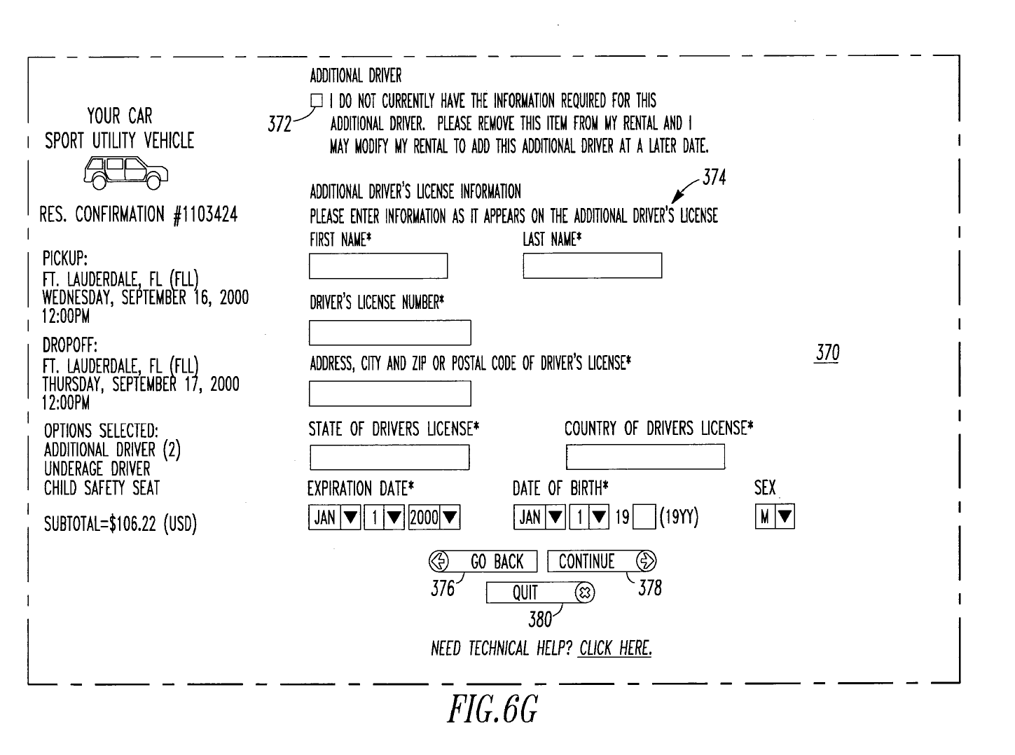

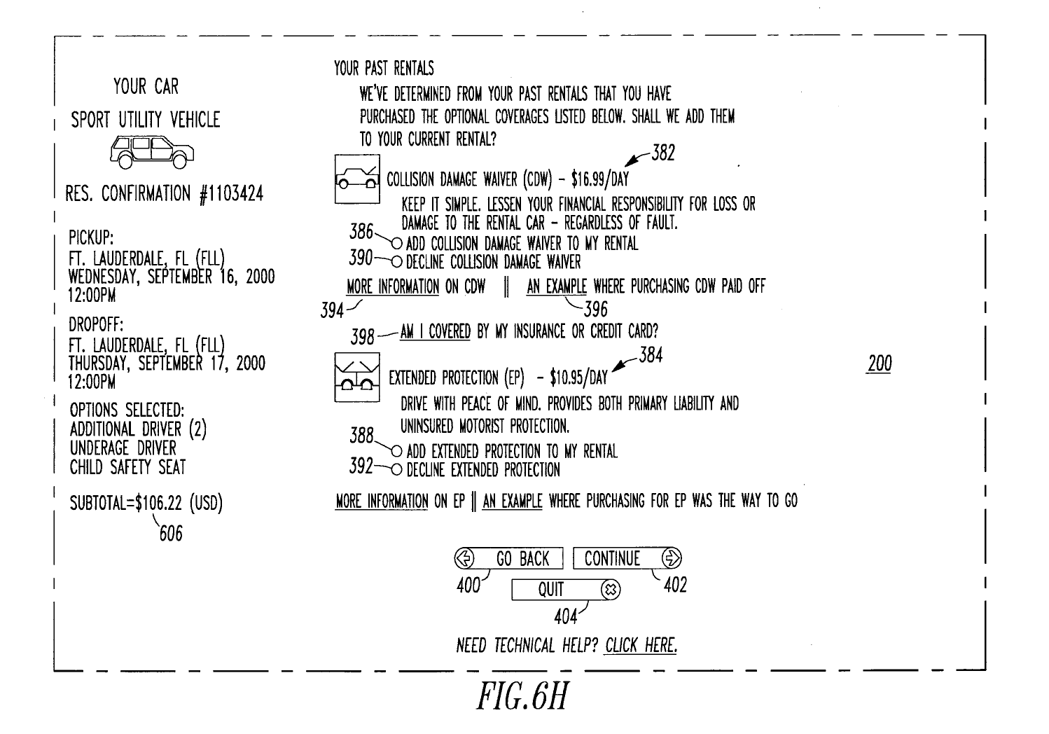

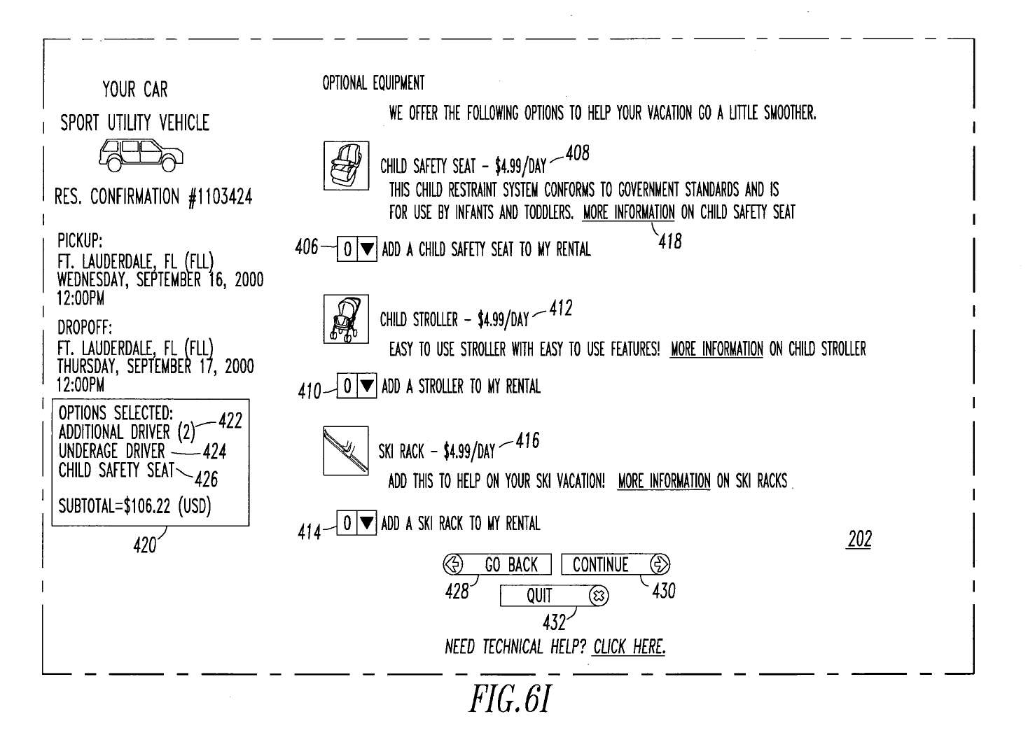

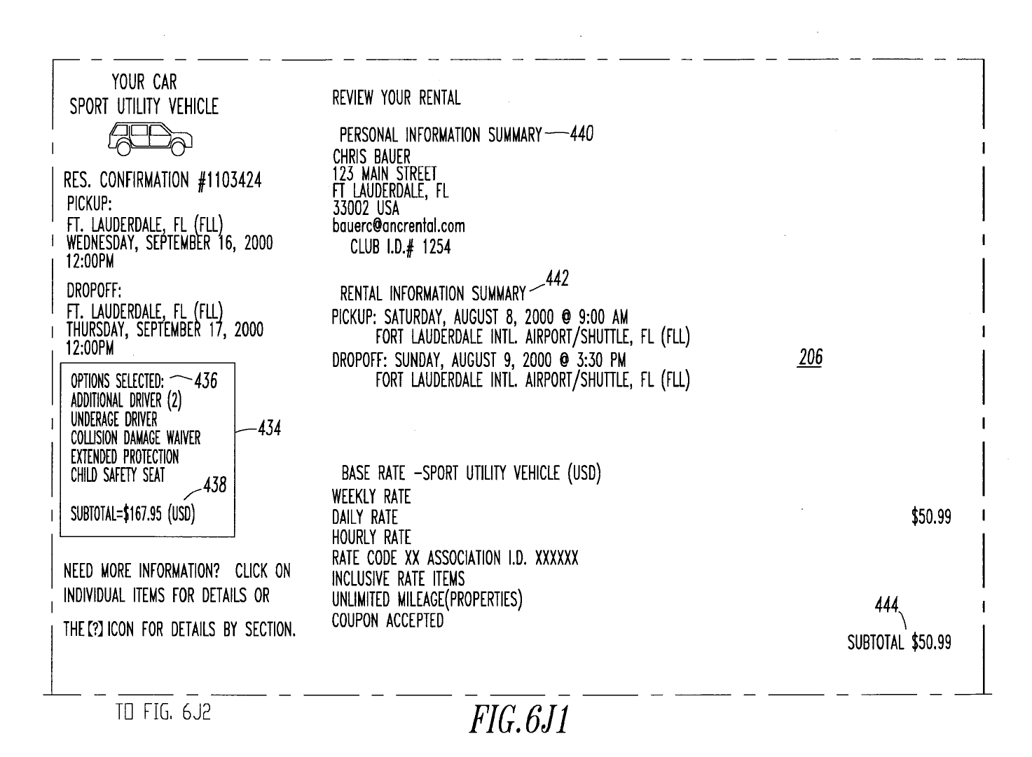

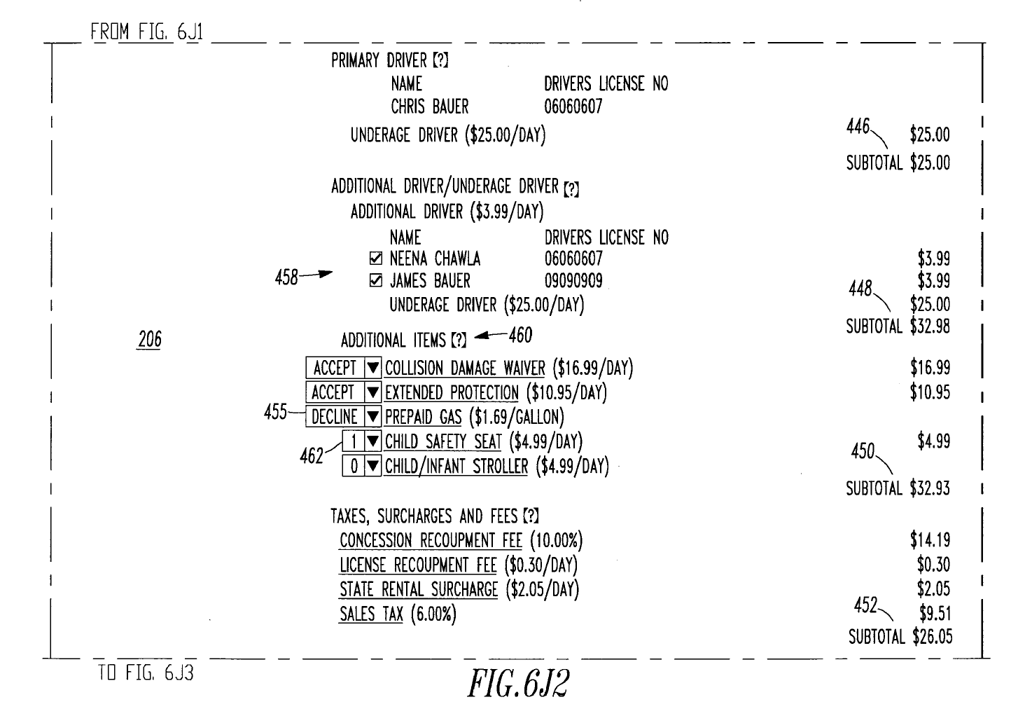

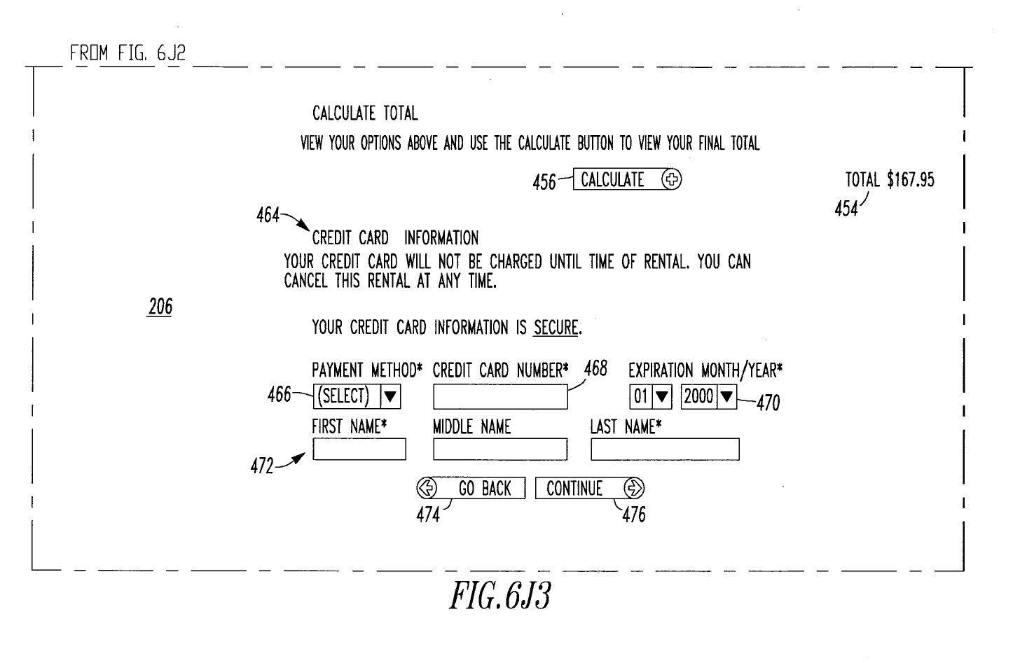

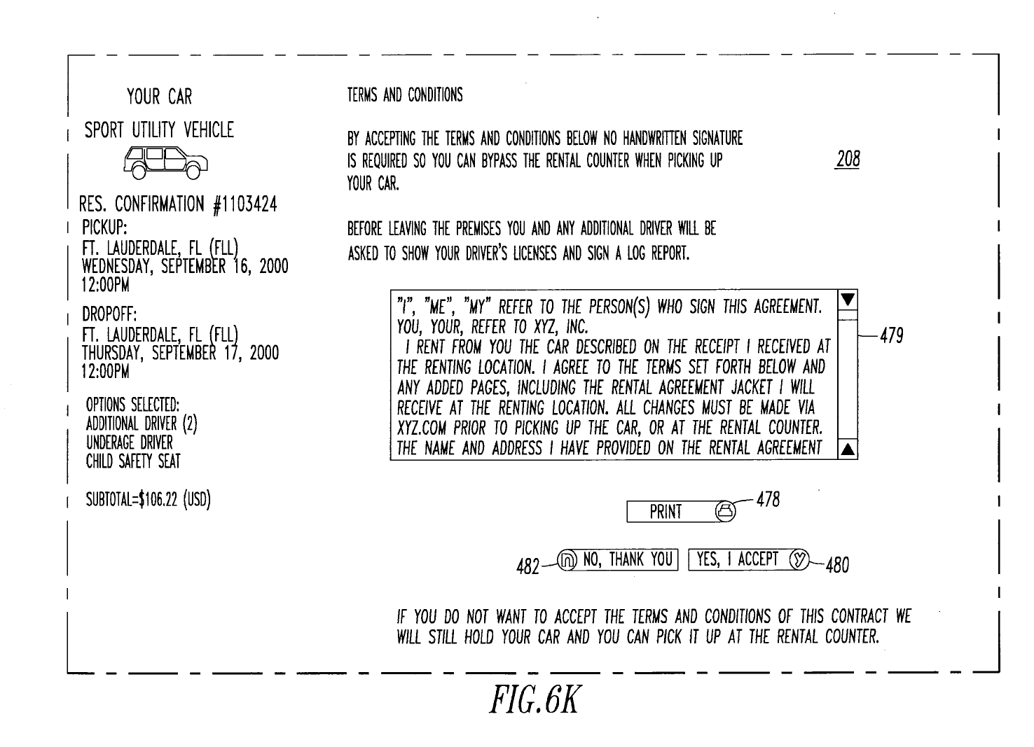

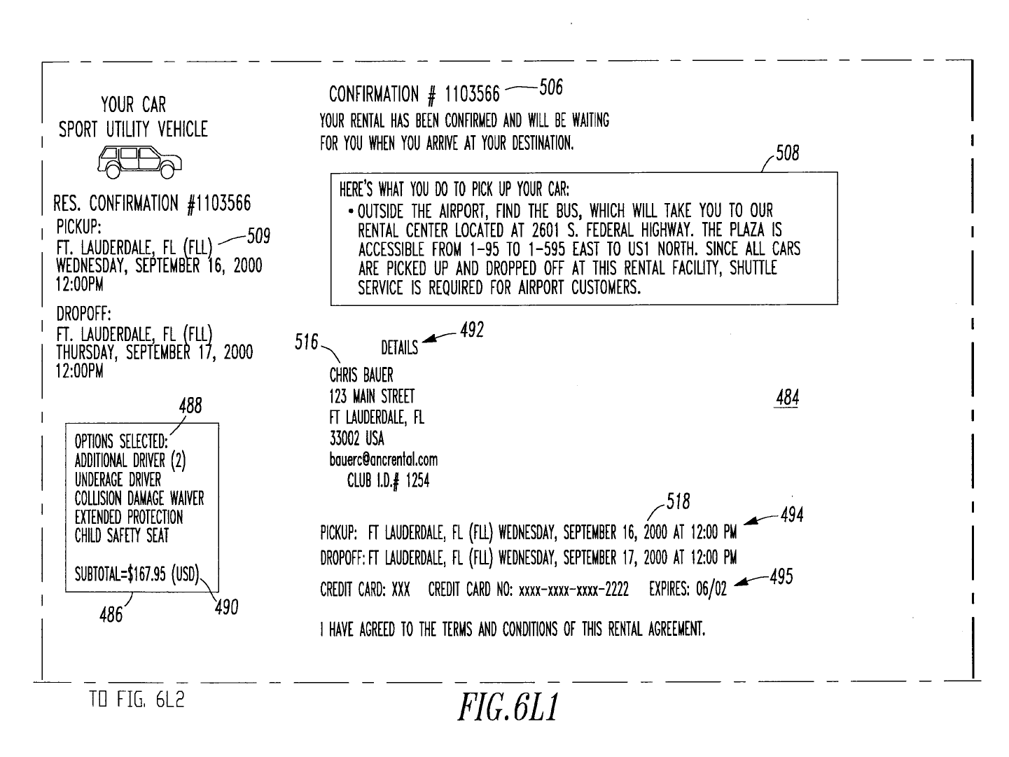

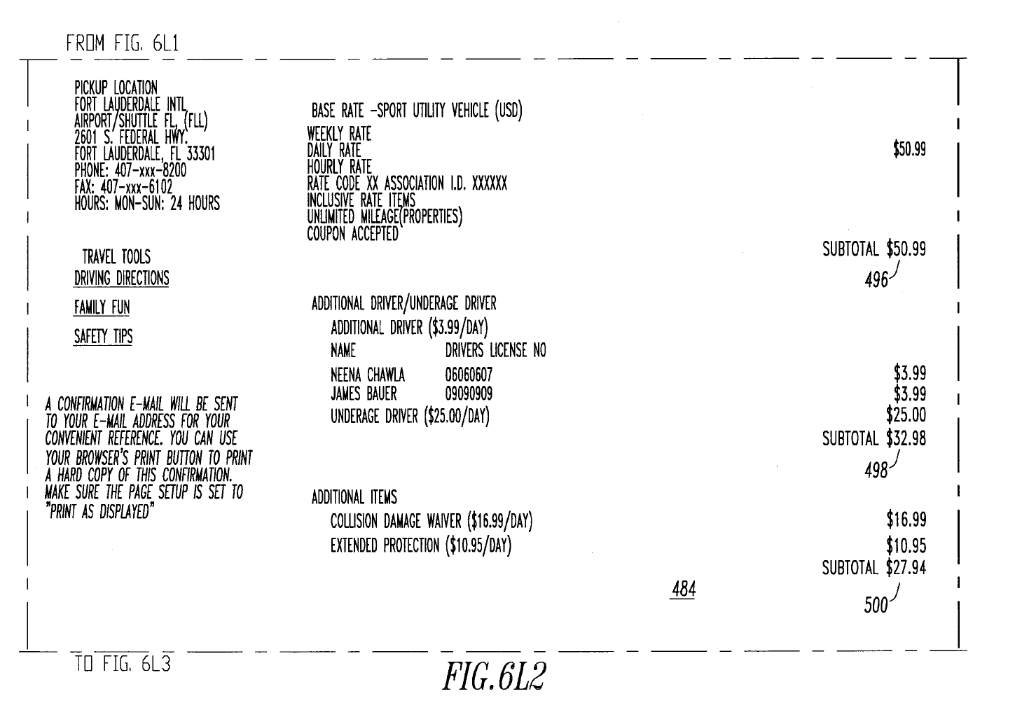

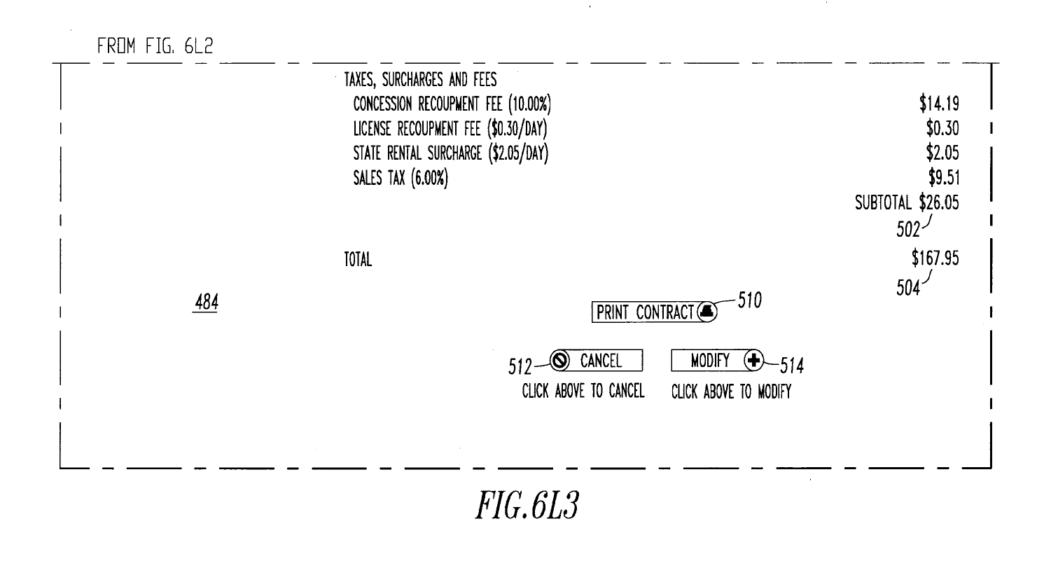

As shown in FIG. 3, at 86, from a “tell us about your trip” web page (FIG. 6B), pick-up and drop-off information and time of travel are entered for the reservation. In the event that a reservation request outside of the relevant jurisdiction (e.g., without limitation, the United States) is specified, then the information is directed to a different booking engine (not shown). Next, at 88, from a “select a vehicle” web page (FIG. 6C), the customer selects an appropriate vehicle based upon various available rental options. In turn, a rate quote 90 is calculated by the reservation system 68 of FIG. 2, in order to provide the customer with a suitable cost estimate based upon the items selected. Next, at 92, if the customer chooses to simply reserve the vehicle, then, at 94, a “reservation confirmation” web page (FIGS. 6E1 and 6E2) is displayed, in order to confirm the reservation and, thereby, inform the customer that the reservation is in the system. Then, at 96, a confirmatory e-mail message is sent to the customer. This e-mail confirms the reservation after the customer has entered all of the reservation-related information and the reservation is in the system.

On the other hand, at 92, if the customer chooses to online rent, then, at 98, a “tell us about yourself” web page (FIGS. 6F1 and 6F2) is displayed. This exemplary web page is a form, which, in the exemplary embodiment, either: (a) pulls the customer's past rentals to pre-populate the form, or (b) allows the customer to manually enter personal and/or “additional driver” (FIG. 6G) information online. Next, at 100, additional sales items are offered to the customer through, for example, a “your past rentals” web page (FIG. 6H) and an “optional equipment” web page (FIG. 6I). These pages allow the customer to be educated on available optional items (e.g., CDW, EP, prepaid gas, ancillary items). Once suitably educated, at 102, a “review your rental” web page (FIGS. 6J1-6J3) is displayed which provides a summary of charges and captures the customer's credit card information. Next, at 104, a “terms and conditions” web page (FIG. 6K) is suitably displayed (e.g., within a pop-up window). Relevant information regarding the reservation/rental process is stored, on a temporary basis, on the database server 64 of FIG. 2 while the transaction is in progress. In addition, information for reporting purposes is also stored on the database server 64. After all the information about the reservation and the rental is entered, the web server 62 of FIG. 2 displays a rental agreement to the customer, with a button 106 entitled “I Accept”. The consumer clicks on the “I Accept” button 106 in order to complete the online rental.

At 108, a “rental confirmation” web page (FIG. 6L1-6L3) is displayed. This web page displays dynamic location specific directions on what to do when the consumer reaches the selected rental facility, and a summary of charges. A “Print” button 110 permits the consumer to print the accepted rental contract.

At 112, a confirmatory e-mail message is sent to the customer. This e-mail confirms the reservation and the rental after the customer has entered all of the reservation-related and rental-related information and the reservation and rental are in the system.

In the event that the customer chose to simply reserve the vehicle, at 92, and received the confirmatory e-mail (as sent at 96), then the customer has the option of entering rental-related information after receiving the e-mail message. Preferably, the confirmatory e-mail message includes a suitable link 114 to step 98, which displays the “tell us about yourself” web page (FIGS. 6F1 and 6F2) to complete the rental agreement.

Preferably, the system provides suitable mechanisms for the customer to modify, at 116, an existing reservation, and/or to modify, at 118, an existing rental.

FIG. 4 illustrates a client/server system 120 including a client sub-system 122 and a server sub-system 124 for completing a rental agreement (RA) 126 therebetween. The client sub-system 122 includes an entry component (E) 128 entering first information 130 pertaining to a reservation of an item or service, and entering second information 132 pertaining to a rental of the item or service. The client sub-system 122 also includes a processor component (P) 133 cooperating with the entry component 128, and a communication component (COMM) 134, responsive to the processor component 133. The communication component 134 sends, at 136, the first and second information 130,132 to the server sub-system 124, and receives, at 138, from the server sub-system 124 a rental proposal 140 responsive to the sent first and second information. Preferably, the rental proposal (RP) 140 is sent as an HTML document, as provided by the server sub-system 124, and the processor component 133 processes the HTML document for display.

The client sub-system 122 further includes a display component, such as the exemplary browser 142, which employs a suitable web page (e.g., FIG. 6C) for selecting the item or service, and which employs one or more suitable web pages (e.g., FIGS. 6J1-6J3 and 6K) for displaying the rental proposal 140. In turn, the entry component 128 and the processor component 133 cooperate to initiate acceptance, at 144, of the rental proposal 140. The communication component 134, responsive to the acceptance, sends the acceptance, at 146, to the server sub-system 124, in order to complete the rental agreement 126 online. Preferably, the server sub-system 124 sends, at 147, the rental agreement 126 to the client sub-system 122 as an HTML document, and the processor component 133 processes the HTML document for display by the browser 142 of the client sub-system 122.

The server sub-system 124 includes a data storage component 148 storing information for a plurality of items or services, and a communication and processing component 150 receiving the first and second information 130,132 from the client sub-system 122. The communication and processing component 150 includes a communication component (COMM) 152 and a processor component (P) 154. The server sub-system 124 also includes a reservation component (RESERVE) 156 which retrieves stored information from the data storage component 148 for the items or services, and provides a reservation (RES) 158 based at least in part upon the first information and the retrieved stored information. The server sub-system 124 further includes a rental component (RENT) 160 generating the rental proposal 140 based upon the reservation 158 and the received second information.

The communication component 152 sends the rental proposal 140 to the client sub-system 122, and receives the acceptance 146 of the rental proposal from the client sub-system 122, in order to complete the rental agreement 126 online. The rental component 160 generates the rental agreement 126 at the server sub-system 124 based upon the accepted rental proposal. The communication component 152 sends the rental agreement 126 from the server sub-system 124 to the client sub-system 122. The processor component 154 cooperates with the communication component 152, the reservation component 156 and the rental component 160 to provide the reservation 158, to send the rental proposal 140 to the client sub-system 122, and to receive the acceptance 146 of the rental proposal from the client sub-system 122, in order to complete the rental agreement 126 online.

Preferably, a suitable communication system, such as a global communication network 164 (e.g., the Internet), communicates between the communication component 134 of the client system 122 and the communication component 152 of the server sub-system 124. Alternatively, the present invention is applicable to entry of reservation-related and rental-related information by employing one or more of a telephone, a global communication network, and electronic mail.

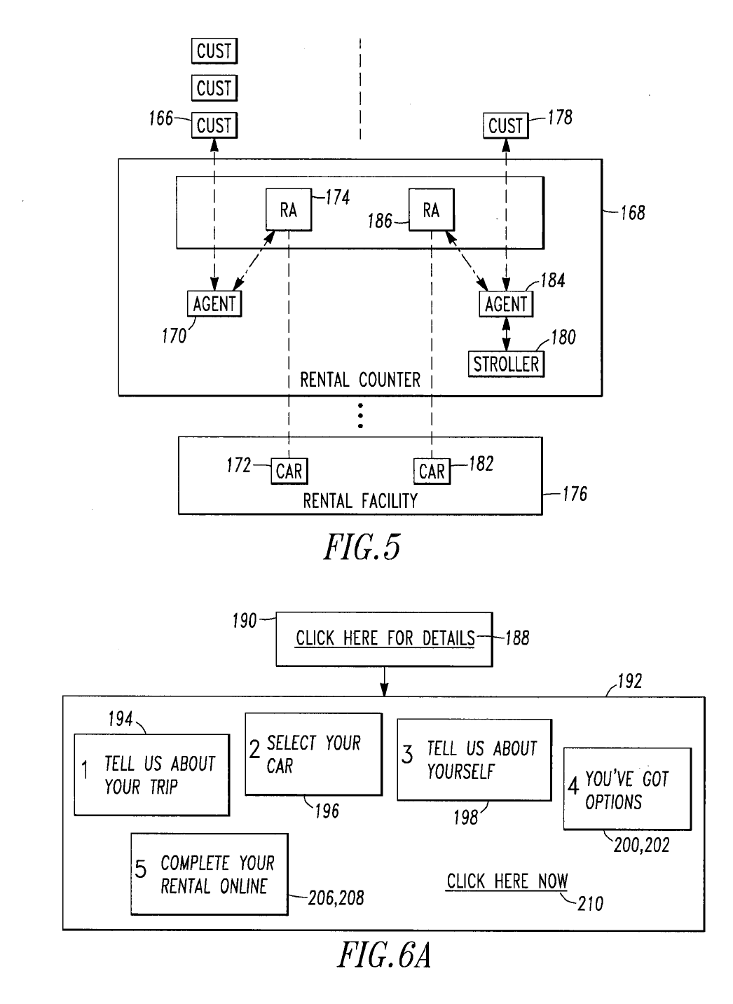

Referring to FIG. 5, regardless whether the reservation and rental were completed online, a customer (CUST) 166 has the ability to go to a rental counter 168 (associated with a rental facility 176). In the event that the reservation or rental was not completed online, then a rental agent 170 at the rental counter 168 has the ability to complete the reservation/rental transaction without going through all the questions (e.g., entry fields) at the rental counter 168 that were previously answered online (e.g., over the Internet). In turn, the rental agent 170 completes the rental by allocating a car 172 and printing the rental agreement (RA) 174. In turn, the customer 166 proceeds to the rental facility 176 to obtain the car 172.

On the other hand, if the reservation and rental were completed online, a customer 178 may still be directed to the rental counter 168, where expedited service is preferably provided, in order to obtain an optional item (e.g., a stroller 180) before obtaining a car 182 for rental. In this event, the customer 178 had previously displayed and accepted a rental proposal (and typically had displayed a rental agreement) online (e.g., at a client system). Preferably, the rental agent 184 provides expedited service to the customer 178 at the rental counter 168 based upon the rental agreement 186, and allocates the car 182 at the rental counter 168. In this instance, the rental agent 184 may also display the rental agreement 186 at the rental counter 168.

FIG. 6A is a block diagram showing a link 188 from a home web page 190 to a second web page 192, which presents an overview of: (1) the “tell us about your trip” web page 194 (FIG. 6B); (2) the “select a vehicle” web page 196 (FIG. 6C); (3) the “tell us about yourself” web page 198 (FIGS. 6F1 and 6F2); (4) the “your past rentals” web 200 (FIG. 6H) and “optional equipment” web page 202 (FIGS. 6I); and (5) the “review your rental” web page 206 (FIGS. 6J1-6J3) and the “terms and conditions” web page 208 (FIG. 6K). A link 210 is provided from the second web page 192 to the “tell us about your trip” web page 194 of FIG. 6B.

The “tell us about your trip” web page 194 of FIG. 6B permits the user to enter reservation-related information, such as time and location information regarding a vehicle rental. This information typically includes at least some of pick-up location 212, pick-up date 214, pick-up time 216, drop-off location 218, drop-off date 220, and drop-off time 222 fields. In addition, a country of residence 224 field is provided.

In the exemplary embodiment, once the customer places the cursor on any of the country of residence 224, pick-up location 212, or drop-off location 218 fields, a suitable location search may be employed to populate the pick-up location 212 for the user, thereby assisting manual entry of the city name or code. The pick-up location 212 field may also support manual entry of the city name, city code, state or country. The drop-off location 218 preferably defaults to the pick-up location 212. The country of residence 224 field preferably employs an alphabetized list of countries with the United States (US), for example, listed both first and in alphabetical order.

Also, in the exemplary embodiment, once the customer places the cursor on any of the pick-up date 214 or drop-off date 220 fields, a suitable interactive calendar is provided for entry of the date information. Preferably, the drop-off month defaults to the pick-up month and is the first month to appear in a drop-down box (not shown).

Although the foregoing entry fields are “required” in the exemplary embodiment, the invention is applicable to data entry in which fewer or greater data fields (e.g., arrival information) are employed. The exemplary web page 194 also employs optional information 224, such as, for example, Rate Code, Promo Code, Corporate ID, and Coupon Code, as known to those skilled in the art. If the customer enters data in the Rate Code, then once a number is entered in the Corporate ID, the Applicant Code 226 field appears and is open for entry. Validation for the Applicant Code is performed on the mainframe 66 of FIG. 2.

Other optional information in the exemplary embodiment includes the Club Member ID 228 field and the Last Name 230 field. In the exemplary embodiment, in order to validate the Club Member ID 228 field on the mainframe 66 of FIG. 2, the Last Name 230 field is entered and captured. Once the customer clicks on the “Continue” button 232 to advance to the web page 196 of FIG. 6C, this validation is performed. If there is an error, then a suitable error message (not shown) is displayed. In the exemplary embodiment, if the customer enters a non-US location into the pick-up or drop-off fields, then upon selecting the “Continue” button 232, the customer is redirected to a suitable international booking engine (not shown).

As shown in FIG. 6B, suitable links are preferably provided to view 234, modify 236, and cancel 238 an existing reservation. Also, a suitable link 240 to technical help is preferably provided to further assist the customer.

FIG. 6C illustrates the exemplary “select a vehicle” web page 196 (after a calculation). This web page 196 permits the customer to select a vehicle for reservation as part of the reservation-related information. Based upon the information from FIG. 6B, the vehicle classes that are available at the requested location for the requested dates are displayed. For example, at 242, an image 244 of the vehicle, a class 246 of the vehicle, and a rental price 248 for the vehicle are initially displayed. Then, the customer clicks on the image 244 or the exemplary radio button 250, in order to reserve that particular class of vehicle. Preferably, the customer may also make an informed selection based upon the capacity 252 of the vehicle. The web page 196 preferably shows one or both of passenger capacity 254 and luggage capacity 256 as the capacity 252 of the available vehicles.

In addition to displaying the rental period and location information 258 from the information entered in FIG. 6B, the rental period price quotation 259, as quoted in the currency of the Rate Code, is received from the mainframe 66 of FIG. 2 and displayed. Also displayed are a vehicle capacity legend 260 and features 262 of the selected vehicle.

The customer may employ the “Go Back” button 264 to return to the web page 194 of FIG. 6B, or the “Continue” button 266 to proceed to the “select rental options and calculate total” web page 268 of FIGS. 6D1 and 6D2.

The web page 268 includes a Base Rate Subtotal 270, a Subtotal 271 based upon the primary driver's age, an Additional Drivers Subtotal 272, an Additional Items Subtotal 273, a Subtotal for Taxes, Surcharges and Fees 274, and an Estimated Total 275. The Additional Items section 276 shows all ancillary items for the selected pick-up location as well as insurance coverage items 277,278 (e.g., Collision Damage Waiver, Extended Protection) and prepaid gas 279. FIG. 6D1 shows examples of available items 280, 281 (e.g., Baby Seat, Ski Rack, Stroller) that can be selected at the time of reservation for the selected rental facility. The mainframe 66 of FIG. 2 sends these items to the web server 62 for display only if they are available. Preferably, hyperlinks, such as 282, appear for each of the above items. When a user clicks on one of these links, a pop-up box (not shown) is displayed that provides descriptive information about the item.

When the customer first arrives at this exemplary web page 268, the base line item totals and Subtotal 270 are displayed along with the Taxes, Surcharges and Fees Subtotal 274, and the Estimated Total 275. Preferably, all other sections do not have line item totals or subtotals. Once the customer manipulates, for example, the drop-down box(es) 284,286 or selects items in the Additional Items section 276, these sections' subtotals disappear along with the Total 275. In order to get these subtotals and Total to appear, the customer clicks on the “Calculate” button 288. In turn, the items selected are captured and the various subtotals and Total are updated by the mainframe 66 of FIG. 2.

If the customer selects the “Reserve” button 290, then the newly calculated subtotals and Total are reflected in the “reservation confirmation” web page 291 of FIGS. 6E1 and 6E2. On the other hand, if the customer clicks on the “Rent” button 292, then the options are saved and used in the sales logic in connection with FIGS. 6H and 6I. In turn, the “tell us about yourself” web page 198 of FIGS. 6F1 and 6F2 is displayed.

Although the following entry fields are “required” in the exemplary reservation and/or rental embodiments: the personal information including First Name 294, Last Name 296, and E-mail address 298 fields, the invention is applicable to data entry in which fewer or greater data fields (e.g., address information) are employed.

As alternatives to the buttons 290,292, the customer may select the “Go Back” button 300 to return to the web page 196 of FIG. 6C, or the “Quit” button 302 to quit the reservation process.

In the event that the customer entered a suitable Member ID 228 in FIG. 6B, the web page 268 displays a list (not shown) of items which are in the customer's master rental agreement (MRA) for that Member ID, as well as other items that are selectable. Here, the customer has three options: First, if no changes are made to the items which were pre-selected, then the user may “Continue” (not shown) (in the same manner as another user upon selecting the “Reserve” button 290) to the “reservation confirmation” web page 291 of FIGS. 6E1 and 6E2. Second, if changes are made, then the customer is notified by a pop-up (not shown) that he/she can either keep the pre-defined selections in the MRA or else proceed with the “Rent” option. If the customer chooses to stick with the MRA, then the selections revert back to those from the MRA user profile and the “reservation confirmation” web page 291 of FIGS. 6E1 and 6E2 is displayed. Third, if the customer chooses the “Rent” button 292, then the “tell us about yourself” web page 198 of FIGS. 6F1 and 6F2 is displayed. Here, personal information, such as, for example, telephone number, driver's license information, and frequent flyer information is pre-filled. However, credit card information is preferably not pre-filled and the customer is, otherwise, treated like a general (i.e., non-MRA) customer for the remainder of the rental process.

FIGS. 6E1 and 6E2 show the “reservation confirmation” web page 291, which indicates that the reservation has been confirmed and which displays a confirmation number 304. Based upon the pick-up location 305, location specific directions 306 are provided. Also, if a Coupon Code was specified in FIG. 6B, then a suitable reminder 307 such as, for example, “Don't forget to bring your coupon to the counter!” is included. Other details regarding the reservation including First Name and Last Name 308, E-mail Address 309, and a detailed summary of the costs including the Estimated Subtotal 310 are provided. As discussed above in connection with FIG. 3, a confirmation e-mail is also sent to the e-mail address 309, which was entered at field 298 of FIG. 6D2.

The web page 291 preferably provides a “Modify” button 312 to display a View/Modify/Cancel jump page (not shown) with Confirmation number 304, Last Name and pick-up date 313 pre-filled. Preferably, a “Cancel” button 314 functions in a similar manner, and a “Return” button 316 returns the customer to the home page 190 of FIG. 6A.

FIGS. 6F1 and 6F2 show the “tell us about yourself” web page 198. Although certain entry fields are “required” in the exemplary web page 198 (i.e., as indicated by “*” in FIGS. 6F1 and 6F2), the invention is applicable to data entry in which fewer or greater data fields for rental-related information are employed. For example, such information may include one or more of the following information regarding a consumer: employing at least one of driver's license information 320 (e.g., license number 322, jurisdiction 324, country 326, expiration date 328, date of birth 330, sex 332), primary driver's personal information 334 (e.g., First Name 336, Last Name 338, E-mail address 340, Street Address 342, City 344, State 346, Postal Code 348, Country 350, and Home Telephone 352), Additional Driver Information 354, travel contact information 356, and Airline and Frequent Flyer Information 358.

Preferably, suitable logic may be employed to validate the driver's license number 322 (e.g., if the state is Florida, then the number must be 12 or 13 digits, with the first digit being alpha and the remaining digits being numeric; if the state is Maryland, then the number must be 13 digits, with the first digit being alpha and the remaining digits being numeric).

An important part of this web page 198 is the “Yes” button 360 through which the customer provides permission to search for past rentals to expedite the rental process and to pre-fill some of the entry fields. If the customer pre-fills the driver's license number 322 and jurisdiction 324 fields, then the mainframe 66 of FIG. 2 employs the same in a search for an exemplary count of the three past rentals on CDW and EP for the sales process of FIG. 6H. If the user selects the “Yes” button 360, then the user is notified of the search by a pop-up box (not shown) and the mainframe 66 performs a check that the Last Name 338 matches the last name which the mainframe stores for the driver's license number 322 in the system. If there is no match, then an error message (not shown) is displayed. If there is a match, then all remaining fields in the Driver's License Information 320 and the Personal Information 334 sections are populated except for telephone number 352. Suitable validation logic employs the Date of Birth 330 field to ensure that the customer is not under the age of 18, and the Expiration Date 328 field (in view of the pick-up date 361) to ensure that the license is valid.

Alternatively, a customer may have other stored user profile information (e.g., stored in a Cookie; corresponding to the user's name or other suitable user identification) that will aid in the entry of the reservation-related and/or rental-related information for the online reservation and rental. Examples of this stored information include: (1) customer information such as, for example, address, driver's license number, and credit card information; and (2) rental preferences such as, for example, vehicle type, and additional rental items (e.g., child safety seat, other ancillary items, insurance items).

For example, the use of this stored user profile information may be enabled or disabled by the use of a suitable button (e.g., “Use Stored User Profile Information”) (not shown) on one or both of the web pages 194 of FIGS. 6B and 291 of FIGS. 6E1 and 6E2. Alternatively, this feature may be automatically enabled through a web log-in process. In this example, the system employs the stored user profile information to pre-populate the reservation-related and rental-related information for the current transaction, in order to improve the speed of information entry. The customer has the opportunity to change the stored information within the reservation/rental process, in order to fit the needs of the current reservation/rental. For example, the user may have a baby and that user's stored user profile information includes a rental preference for a child safety seat. However, for the current rental/reservation, the user does not plan to travel with the baby and, hence, seeks to complete the current reservation/rental with no child safety seat. Preferably, the system provides this function without modifying the stored user profile information.

Referring to FIG. 6F2, the customer may select the “Go Back” button 362 to return to the web page 268 of FIGS. 6D1 and 6D2, the “Continue” button 364 to proceed to the next web page 200 of FIG. 6H, or the “Quit” button 366 to quit the rental process. When the rental-related information has been suitably entered, and the “Continue” button 364 is selected (and no additional drivers are specified), then entry of all “required” fields is validated along with the driver's age, license number and expiration date. However, in the event that any additional drivers are selected, at 368, then the “additional driver” web page 370 of FIG. 6G is displayed.

At the web page 370 of FIG. 6G, the customer may: (1) select the checkbox 372; or (2) enter the additional driver's license information 374. If the checkbox 372 is selected, then the additional driver information 354 of FIG. 6F1 is ignored and none of the entry fields from the web page 370 is captured or validated. Otherwise, the information is captured and validated.

The customer may select the “Go Back” button 376 to return to the web page 198 of FIGS. 6F1 and 6F2, the “Continue” button 378 to proceed to the next web page 200 of FIG. 6H, or the “Quit” button 380 to quit the rental process. When the additional driver's license information 374 has been suitably entered, and the “Continue” button 378 is selected, then entry of all “required” fields is validated along with the driver's age, license number and expiration date.

FIG. 6H shows the “your past rentals” web page 200. If the customer clicked on the “Yes” button 360 of FIG. 6F1, then the following exemplary logic is employed to perform a suggestive sell for the collision damage waiver (CDW) 382 and extended protection (EP) 384. However, no suggestive sell is provided for those optional insurance coverages that are selected by the exemplary add buttons 386,388.

For CDW, if the customer has two or three rentals in the past and only selected CDW less than 50% of the time, then the sales process is very informative of the product and emphasizes the benefits. If CDW was selected greater than or equal to 50% of the time, then the sales process involves suggestive selling. For example, the text “You seemed to have chosen CDW in the past, you will probably want to select this option again . . . ” is employed. Similar logic is employed for EP. Regardless, the add 386,388 and decline 390,392 buttons are not pre-selected in the exemplary embodiment. Preferably, the customer must make an affirmative selection of two of those buttons.

Although the exemplary embodiment does not employ sales logic for a prepaid gas option, it will be appreciated that such logic may be applied to this and a wide variety of other rental options. As shown with the CDW option, suitable links are provided for the customer to obtain more information 394, view an example 396 in which purchasing CDW paid off, and determine if the user is covered 398 by insurance or credit card.

The customer may select the “Go Back” button 400 to return to the web page 198 of FIGS. 6F1 and 6F2, the “Continue” button 402 to proceed to the next web page 202 of FIG. 6I (if one of the buttons 386,390 and one of the buttons 388,392 have been selected), or the “Quit” button 404 to quit the rental process.

FIG. 6I shows the “optional equipment” web page 202 that permits the inclusion of a selected count of the optional rental equipment in the rental-related information. For example, the customer may select a count 406 of Child Safety Seats 408, a count 410 of Child Strollers 412, and a count 414 of Ski Racks 416. Suitable links; such as 418 for the Child Safety seat 408, are provided to obtain additional information regarding the rental options.

This web page 202 also includes a summary 420 of all options as currently selected (e.g., two additional drivers 422, an underage driver 424, and a child safety seat 426), along with the Subtotal and Currency. If optional equipment items were selected earlier in the reservation/rental process, then those do not appear on this page. Similarly, if all available options have been previously selected, then this web page 202 is not displayed.

The customer may select the “Go Back” button 428 to return to the web page 200 of FIG. 6H, the “Continue” button 430 to proceed to the next web page 206 of FIGS. 6J1-6J3, or the “Quit” button 432 to quit the rental process.

FIGS. 6J1-6J3 show the “review your rental” web page 206. This web page 206 includes a summary 434 of all options as currently selected 436 along with the Subtotal and Currency 438. The web page 206 further includes a Personal Information Summary 440, a Rental Information Summary 442, Base Rate Subtotal 444, a Primary Driver Subtotal 446, an Additional Driver Subtotal 448, an Additional Items Subtotal 450, a Taxes, Surcharges and Fees Subtotal 452, and a Total estimate 454.

If a customer manipulates the options (e.g., chooses “Accept” from the drop-down box 455 for Prepaid Gas), then the Subtotal 450, for example, disappears along with the Total 454. In order to get the Subtotal(s) and Total to appear, the customer clicks on the “Calculate” button 456, the items selected are captured by the web server 62, and the various Subtotals and Total are updated by the mainframe 66 of FIG. 2. For example, the checkboxes 458 may be employed to deselect one or both of the additional drivers. The Additional Items section 460 shows all the ancillary items for the selected pick-up location, as well as insurance coverage items and prepaid gas, which have been sent by the mainframe 66 of FIG. 2. The exemplary optional items are displayed by the web server 62 if they have been selected through the sales process (e.g., the mainframe 66 sent them earlier in the process). The CDW, EP and Prepaid Gas options employ drop-down boxes, such as 455, with values “Accept” and “Decline”. The other ancillary optional items employ drop-down boxes, such as 462, having various counts for that option. The exemplary drop-downs allow the customer to opt in or out of an optional item.

The web page 206 further includes Credit Card Information 464 including Payment method 466 (e.g., type of credit card), Card Number 468, Expiration Date 470, and the Name 472 on the card (e.g., First Name, Middle Initial or Name, Last Name). Preferably, suitable validation of the credit card information is employed. In a preferred embodiment, a validation is performed to check that the last name on the credit card equals the last name as entered for the primary driver. If these names do not match, then a suitable error message (not shown) is displayed.

The customer may select the “Go Back” button 474 to return to the web page 202 of FIG. 6I, and the “Continue” button 476 to validate the “required” fields and proceed to the next web page 208 of FIG. 6K.

FIG. 6K shows the “terms and conditions” web page 208, which includes a “Print” button 478 to permit the customer to print the displayed terms and conditions 479, a “Yes” or “Accept” button 480 to accept the rental agreement under those terms and conditions 479, and a “No” button 482 to reject the rental agreement (but keep the reservation). The text for the rental terms and conditions 479 preferably appears within a pop-up or scrolling text box, with any state specific disclosure appearing at the bottom of static terms and conditions text. By clicking on the object (i.e., selecting the “Yes” button 480), the customer accepts the rental terms and conditions and, thereby, includes them in the rental agreement. If the customer selects the “No” button 482, then the “reservation confirmation” web page 291 of FIGS. 6E1 and 6E2 is displayed. Otherwise, if the customer selects the “Yes” button 480, then the “rental confirmation” web page 484 of FIGS. 6L1-6L3 is displayed.

FIGS. 6L1-6L3 shows the “rental confirmation” web page 484, which includes a summary 486 of all options as currently selected 488 along with the Subtotal and Currency 490. The web page 484 further includes a Personal Information Summary 492, a Rental Information Summary 494, redacted (e.g., only the last four digits) Credit Card Information 495, Base Rate Subtotal 496, an Additional Driver Subtotal 498, an Additional Items Subtotal 500, a Taxes, Surcharges and Fees Subtotal 502, and a Total estimate 504. The web page 484 also includes a Confirmation number 506 at the top of the exemplary page, along with pick-up location specific directions 508. For example, the directions 508 include instructions for a consumer at a rental facility (e.g., in Ft. Lauderdale, Fla.). Based upon the user selection of the pick-up location 509 from the various different rental facilities, the system dynamically provides the instructions based upon the selected rental facility, in order to customize it for that selected facility. Preferably, a suitable dynamic message is also provided if the customer has selected one or more ancillary items or has used an upgrade coupon (e.g., “Don't forget to go to the Rental Counter to get your: UPGRADE/CHILD SEAT/STROLLER (inserted here—depending on what was selected)).

The web page 484 further includes a “Print” button 510 to permit the customer to print the final rental agreement, a “Cancel” button 512 to cancel the rental agreement, and a “Modify” button 514 to modify the rental agreement. The “Cancel” button 512 and the “Modify” button 514 both send the customer to a View/Modify/Cancel jump page (not shown) with Confirmation number 506, Last Name 516, and pick-up date 518 pre-filled.

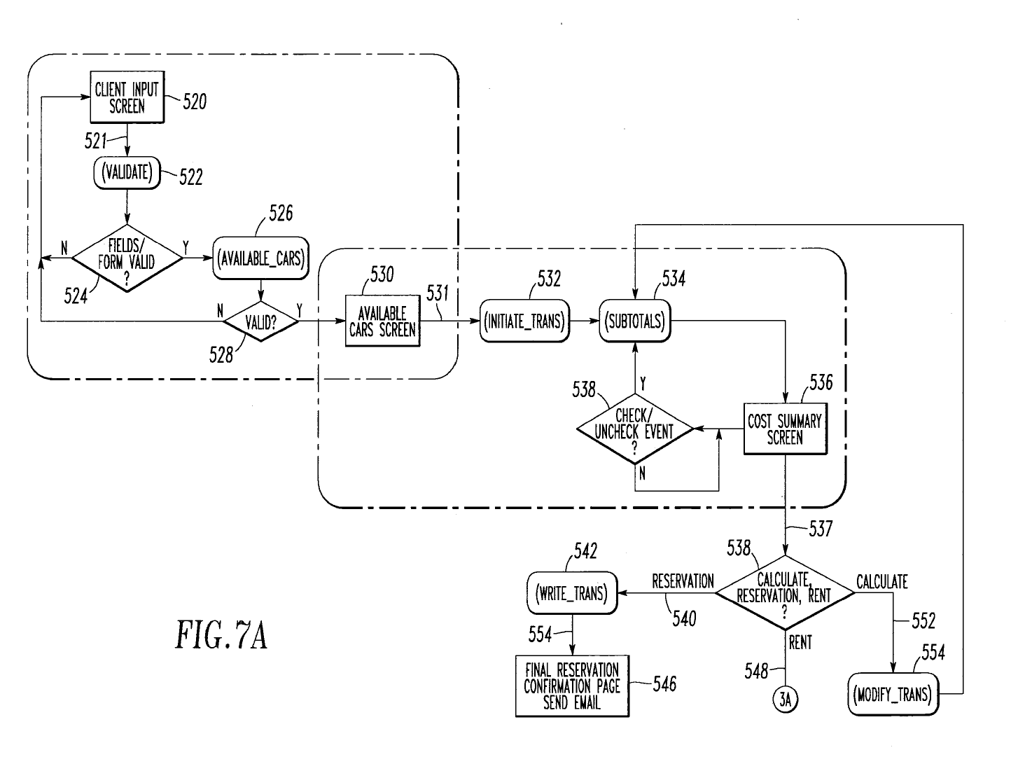

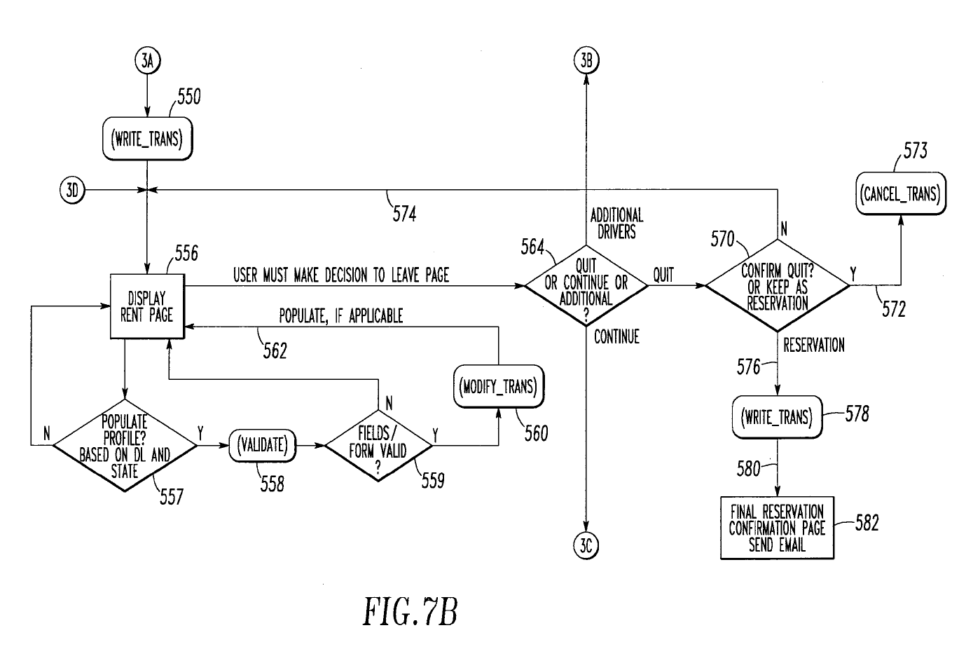

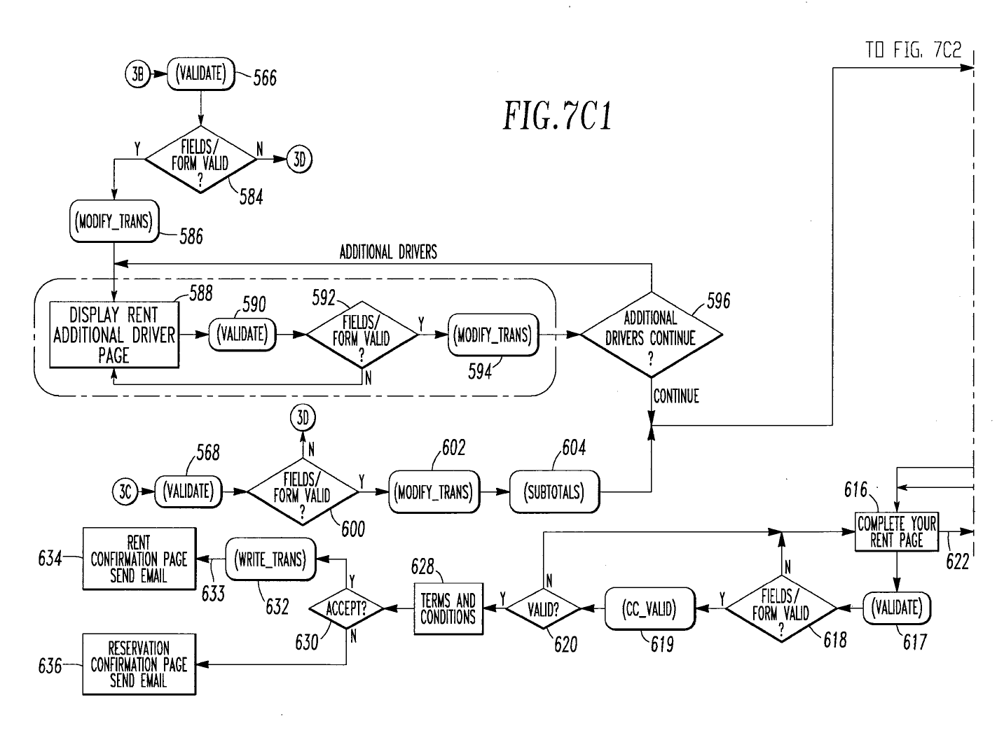

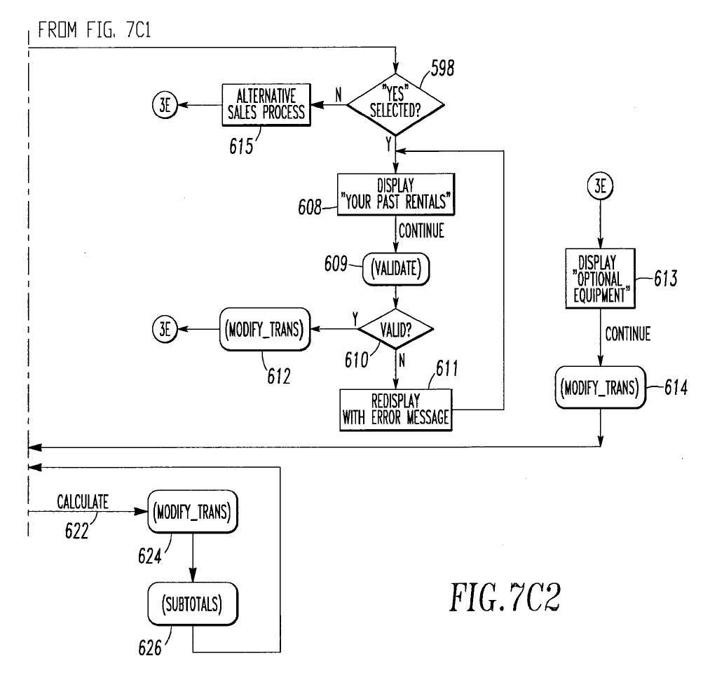

FIGS. 7A-7C2 are flow diagrams for the web server 62, database server 64 and mainframe 66 of FIG. 2. At 520, the web server 62 displays the web page 194 of FIG. 6B. At 521, the web server 62 detects the selection of the “Continue” button 232 and employs the database server 64 to validate some of the entry fields of the web page 194. At 524, if the entry fields are valid, then, at 526, the web server 62 employs the mainframe 66 to generate the available vehicle information for the web page 196 of FIG. 6C. On the other hand, if an entry field was not valid, then the web server 62 redisplays the web page 194, at 520, along with a suitable error message (not shown). At 528, after 526, if the mainframe 66 determines that one or more entry fields are not valid (e.g., the Rate Code of FIG. 6B), then the web server 62 redisplays, at 520, the web page 194 along with a suitable error message. Otherwise, if the entry fields of the web page 194 are valid, then the web server 62 displays the web page 196 of FIG. 6C at 530.

At 531, after the customer selects the appropriate vehicle, the web server 62 detects the selection of the “Continue” button 266 and, at 532, employs the mainframe 66 to generate the cost information for the web page 268 of FIGS. 6D1 and 6D2. In response, the web server 62 updates, at 534, the various subtotals and, at 536, displays the web page 268. At 538, the web server 62 determines if any options of the web page 268 have been changed (e.g., checked or unchecked). If not, then step 538 is repeated. Otherwise, if any of the options are changed, then the web server 62 updates, at 534, the various subtotals and, at 536, redisplays the web page 268.

As part of step 536, if the web server 62 detects, at 537, the selection of the “Calculate” button 288, the “Reserve” button 290, or the “Rent” button 292, then, at 538, the web server makes a one-of-three decision. If the “Reserve” button 290 is detected, at 540, then the web server 62 writes, at 542, a reservation transaction to the mainframe 66, which stores the transaction as part of the reservation system 68 of FIG. 2. In response to a confirmation, at 544, from the mainframe 66, the web server 62 displays, at 546, the reservation confirmation web page 291 of FIGS. 6E1 and 6E2 and sends the customer an e-mail message to confirm the reservation.

Alternatively, if the “Rent” button 292 is detected, at 548, then the web server 62 writes, at 550 of FIG. 7B, a reservation transaction to the mainframe 66, which stores the transaction as part of the reservation system 68 of FIG. 2. Finally, if the “Calculate” button 288 is detected, at 552, then the web server 62 writes, at 554, a modify transaction to the mainframe 66, which re-calculates the various rental cost Subtotals and Total of FIGS. 6D1 and 6D2, after which the web server 62 updates, at 534, the various subtotals and, at 536, redisplays the web page 268.

After step 550 of FIG. 7B, the web server 62 displays, at 556, the web page 198 of FIGS. 6F1 and 6F2. At 557 (as part of 556), the web server 62 determines whether to populate the various entry fields based upon the state of the “Yes” button 360. If the button 360 is not selected, then the web server 62 continues to await selection of one of the “Yes” button 360, the “Continue” button 364, the “Go Back” button 362, and the “Additional Driver” pull-down 368. Otherwise, if the “Yes” button 360 was selected, at 557, then the web server 62 employs, at 558, the database server 64 to validate some of the entry fields (including, but not limited to, the license number 322 and jurisdiction 324 fields) of the web page 198. If an entry field was not valid, at 559, then the web server 62 redisplays the web page 198, at 556, along with a suitable error message. On the other hand, if the entry fields are valid, at 559, then, at 560, the web server 62 employs the mainframe 66, as discussed above in connection with FIGS. 6F1 and 6F2, to: (1) search for the customer's past rentals (e.g., a count of three) to obtain a history of CDW and EP selections, and (2) perform a check that the Last Name 338 matches the last name which the mainframe 66 has stored for the driver's license number 322 in the system. If there is a match, then, at 562, the web server 62 obtains from the mainframe 66 the remaining fields in the Driver's License Information 320 and the Personal Information 334 sections, except for telephone number 352, and populates the same in the entry fields of the web page 198, which is redisplayed, at 556.

At 564 (as part of 556), the web server 62 determines whether one of the “Continue” button 364, the “Go Back” button 362, and the “Additional Driver” pull-down 368 is selected. If so, and if the “Additional Driver” pull-down 368 is selected, then execution resumes at 566 of FIG. 7C1. If the “Continue” button 364 is selected, then execution resumes at 568 of FIG. 7C1. Otherwise, if the “Quit” button 366 is selected, then, as part of the quit logic, the web server 62 provides the user with one of two options as part of a pop-up window (not shown) that are tested, at 570: (1) if the selection of a “Yes” button is detected, at 572, then the “quit” is confirmed and a cancel transaction is written, at 573, to the mainframe 66 to cancel the reservation (and no rental is completed); and (2) if the selection of a “No” button is detected, at 574, then the “quit” is terminated (and the reservation is kept) and execution resumes at 556. If the selection of a “Reservation” button is detected, at 576, then a reservation transaction is written, at 578, to the mainframe 66, which stores the transaction as part of the reservation system 68 of FIG. 2 (and no rental is completed). In response to a confirmation, at 580, from the mainframe 66, the web server 62 displays, at 582, the reservation confirmation web page 291 of FIGS. 6E1 and 6E2, and sends the customer an e-mail message to confirm the reservation.

In FIG. 7C1, after the “Additional Driver” pull-down 368 of FIG. 6F2 is selected, the web server 62 employs, at 566, the database server 64 to validate some of the entry fields. If an entry field was not valid, at 584, then the web server 62 redisplays, at 556 of FIG. 7B, the web page 198 of FIGS. 6F1 and 6F2 along with a suitable error message. Otherwise, if the entry fields are valid, then the web server 62 initiates, at 586, a modify transaction to the mainframe 66 to update the “Additional Driver” information. Then, the web server 62 displays, at 588, the web page 370 of FIG. 6G.

Next, the web server 62 employs, at 590, the database server 64 to validate some of the entry fields. If an entry field was not valid, at 592, then the web server 62 redisplays, at 588, the web page 370 of FIG. 6G along with a suitable error message. Otherwise, if the entry fields are valid, then the web server 62 initiates, at 594, a modify transaction to the mainframe 66 to update the “Additional Driver” information.

Based upon the count from the “Additional Driver” pull-down 368 of FIG. 6F2, the web server 62 determines, at 596, whether information for any additional drivers should be entered. If so, then an internal count is decremented and execution resumes, at 588, for a “second” additional driver. This process repeats until the internal count is zero, at 596, and the “Continue” button 378 of FIG. 6G is detected, at 597. Next, the web server 62 conditionally displays, at 608, the web page 200 of FIG. 6I-1.

If the “Continue” button 364 of FIG. 6F2 is selected, then execution resumes, at 568 of FIG. 7C1. The web server 62 employs, at 568, the database server 64 to validate some of the entry fields of the web page 198 of FIGS. 6F1 and 6F2. If an entry field was not valid, at 600, then the web server 62 redisplays, at 556 of FIG. 7B, the web page 198 of FIGS. 6F1 and 6F2 along with a suitable error message. Otherwise, if the entry fields are valid, then the web server 62 initiates, at 602, a modify transaction to the mainframe 66 to update the rental information. Next, at 604, the web server 62 updates, as needed, the Subtotal 606 of FIG. 6H before conditionally displaying, at 608, the web page 200.

At 598 (FIG. 7C2), if the “Yes” button 360 of FIG. 6F1 was selected, then at 608, the web server 62 of FIG. 2 displays the web page 200 of FIG. 6H. At this point, the customer may ADD or DECLINE the CDW, EP and Prepaid Gas options (only the CDW and EP options are shown in FIG. 6H), by using the ADD 386,388 and DECLINE 390,392 buttons. Then, after the “Continue” button 402 is detected, the web server 62 validates, at 609, the information to ensure that each option was either accepted (ADD) or declined (DECLINE). At 610, if any option was neither accepted nor declined, then the web server 62 redisplays, at 611, the web page 200 along with a suitable error message (not shown). Otherwise, at 612, the web server 62 writes a modify transaction (in order to update the selection) to the mainframe 66 of FIG. 2, before resuming execution at 613.

At 613, the web server 62 displays the web page 202 of FIG. 6I. At this point, the customer may increase or decrease the counts 406,410,414 of the respective ancillary items 408,412,416 by employing the corresponding pull-downs. Then, after the “Continue” button 430 is detected, the web server 62 writes, at 614, a modify transaction (in order to update the selected counts) to the mainframe 66 of FIG. 2, before resuming execution at 616.

On the other hand, if, at 598, the “Yes” button 360 of FIG. 6F1 was not selected, then, at 615, the web server 62 of FIG. 2 employs a different sales process for the CDW, EP and Prepaid Gas options. Here, the customer is presented with a web page (not shown) that describes the benefits of the particular option along with the ability to use pop-ups (not shown) for more details. The two operative actions on this web page are “Accept” or “Decline” (the particular option), after which the customer may either “Continue” or “Quit” the rental process. If the customer selects “Quit”, then a pop-up box (not shown) is displayed in order to provide two options to: (1) quit the rental transaction, but keep the reservation; or (2) quit the rental transaction and cancel the reservation. If the customer selects “Continue”, then the web server 62 validates the entry, in order to ensure that the customer suitably selected the option by either accepting or declining that option. If a proper selection was made, then the web server 62 writes a modify transaction to the mainframe 66 of FIG. 2, before displaying a subsequent web page (not shown) for the next option. Otherwise, the previous web page is redisplayed along with a suitable error message. After 615, and selection of the exemplary three options, execution resumes at 613.

At 616, the web server 62 displays the web page 206 of FIG. 6J1-6J3. At 617, the web server 62 detects the selection of the “Continue” button 476 and employs the database server 64 to validate some of the entry fields of the web page 206. If the entry fields are valid, at 618, then the web server 62 employs, at 619, the mainframe 66 to validate the other entry fields of the web page 206. If, at 620, the mainframe 66 determines that one or more entry fields are not valid, then the web server 62 redisplays the web page 206, at 616, along with a suitable error message. Similarly, if the entry fields are not valid, at 618, then the web server 62 redisplays the web page 206, at 616, along with a suitable error message. Finally, if the “Calculate” button 456 of FIG. 6J3 is detected, at 622, then the web server 62 writes, at 624, a modify transaction to the mainframe 66, which re-calculates the various rental cost Subtotals and Total of FIGS. 6J1-6J3, after which the web server 62 updates, at 626, the various subtotals and, at 616, redisplays the web page 206. If there are no changes, then there is no re-calculation and the customer may continue. Otherwise, if there are changes, then the customer hits “Calculate” to continue the transaction.

On the other hand, at 620, if the mainframe 66 determines that the entry fields are valid, then the web server 62 displays, at 628, the web page 208 of FIG. 6K. If the “Accept” button 480 of FIG. 6K is detected, at 630, then the web server 62 writes, at 632, a rental transaction to the mainframe 66, which stores the rental transaction as part of the rental system 70 of FIG. 2. In response to a confirmation, at 633, from the mainframe 66, the web server 62 displays, at 634, the rental confirmation web page 484 of FIGS. 6L1-6L3, and sends the customer an e-mail message to confirm the reservation and rental.

Otherwise, if the selection of the “No” button 482 of FIG. 6K is detected, at 630, then the web server 62 displays, at 636, the reservation confirmation web page 291 of FIGS. 6E1 and 6E2, and sends the customer an e-mail message to confirm the reservation (an no rental is completed).

As disclosed above in connection with FIGS. 6A-6L3 and 7A-7C2, a customer employs, for example, the client system (PC) 26 of FIG. 2 which communicates with the web site 72 in order to provide a vehicle reservation. In turn, the customer inputs rental-related information, and chooses to accept or decline various rental options (e.g., CDW, EP, prepaid gas, ancillary items). In turn, the web server 62 provides the “terms and conditions” web page 208 of FIG. 6K, and the customer employs the exemplary “Accept” button 480, in order to electronically accept the terms and conditions of the rental agreement online.

When the customer clicks on the “Accept” button 40, the web server 62 of FIG. 2 writes a reservation and rental transaction to the mainframe 66, which stores the transaction as part of the rental system 70 of FIG. 2. This transaction indicates that this customer has completed the reservation/rental process and has accepted the rental proposal. In turn, the final reservation and rental information is stored until the time of pick-up of the selected vehicle at the selected car rental facility. The “Accept” button 480 acts as the customer's electronic signature, which electronically accepts the terms and conditions of the rental proposal, and other related information of the rental agreement.

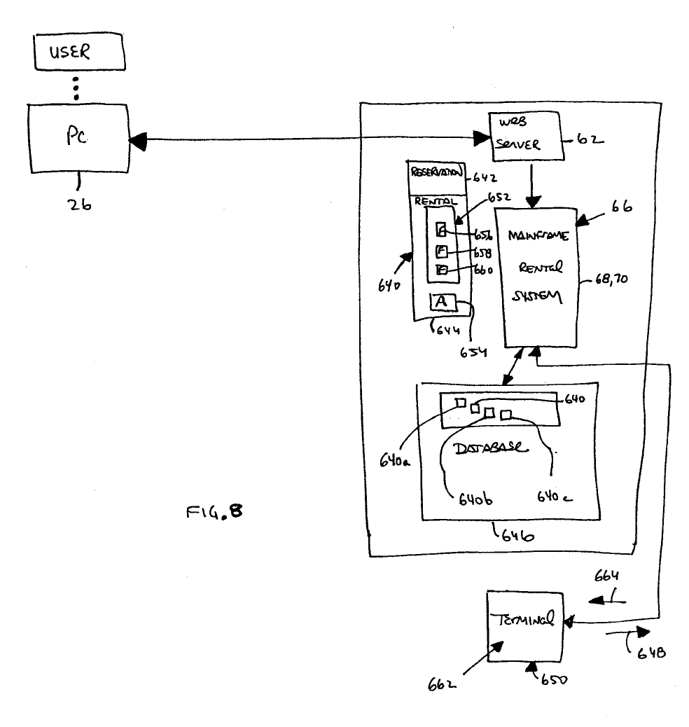

Referring to FIG. 8, a block diagram illustrates the process of storing a unique reservation and rental transaction 640 at the exemplary mainframe 66 of FIG. 2 for each accepted rental proposal. The exemplary transaction 640 includes: (1) a reservation transaction 642 (e.g., as written, at 542 of FIG. 7A), and (2) a rental transaction 644 (e.g., as written, at 632 of FIG. 7C1). These transactions 642 and 644 are sent as suitable messages from the web server 62 to the reservation and rental systems 68 and 70, respectively, with the latter message being responsive to the customer's electronic acceptance of the rental proposal. The rental system 70, in turn, stores the transaction 640 representing the particular electronic rental agreement in a suitably protected database 646. The information of the transaction 640 is maintained in the database 646, which may be accessed, at one or more future times, via a queries, such as query 648, from a terminal 650.

In additional to various rental-related information, the rental transaction 644 further includes rental options 652, and an electronic acceptance 654 of the terms and conditions of the accepted rental proposal/rental agreement. Along with the rental options 652, three exemplary flags (F) 656,658,660 are stored with the transaction 640 in the database 646. These flags signify certain rental options that the customer has accepted or declined. In the exemplary embodiment, the flags 656,658 and 660 correspond to the exemplary CDW, EP, and prepaid gas options, respectively, and signify which of those rental options that the customer has accepted or declined.

The acceptance (A) 654, which in the exemplary embodiment is another flag, is stored with the transaction 640 in the database 646. The flag 654 designates that the particular transaction 640 is an “online rental”. As part of the subsequent vehicle rental by the customer, the exemplary car rental facility 176 of FIG. 5 may employ this flag 654, for example, to permit the customer to bypass the exemplary rental counter 168 of FIG. 5 (e.g., and to proceed directly to a kiosk (not shown) at the facility 176, in order to enable allocation of the selected rental vehicle at the kiosk), or to provide expedited service at the rental counter 168 (e.g., to allow the customer to pick-up an optional rental item, such as a stroller). The exemplary flag 654 is stored in association with the reservation transaction 642 in the database 646 as an electronic signature, thereby showing electronic acceptance of the rental terms and conditions by the customer. In this manner, the flag 654 indicates that the transaction 640 and, thus, the corresponding accepted rental proposal, is electronically signed.

The exemplary flags 656,658,660 are stored for future reference in order to confirm which rental options the customer has accepted and/or declined. The exemplary flag 654 is further stored for future reference in order to confirm that the customer has electronically accepted (and “signed”) the electronic “document” in order to confirm acceptance of the rental terms and conditions, in case that information is needed at a future date (e.g., the customer was involved in a traffic accident with the selected rental vehicle and it, therefore, is necessary to determine Whether or not the customer is eligible for one or both of the exemplary CDW and EP insurance coverages).

The exemplary terminal 650 includes a terminal process 662 which employs the query 648 to retrieve, at 664, the stored flags 654,656,658,660 for a particular transaction, such as 640, of the various rental transactions 640a,640b,640c in the database 646, in order to determine whether the particular customer associated therewith accepted or declined the rental options based upon the retrieved stored flags.

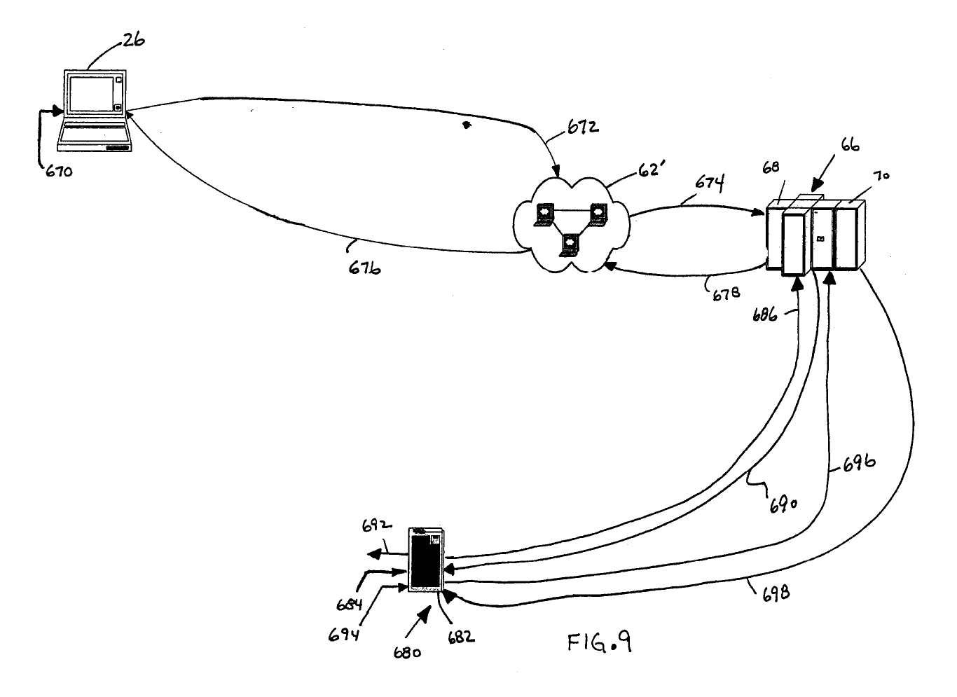

Referring to FIG. 9, a block diagram of another process of storing a unique reservation and rental transaction is illustrated. First, at the client system (PC) 26, the customer enters, at 670, reservation-related information (and, optionally, certain rental-related information) and chooses to accept or decline various rental options (e.g., CDW, EP, prepaid gas, ancillary items). Then, at 672, the system writes the reservation-related information to the exemplary web server cluster 62′, which, in response, writes a reservation transaction, at 674 (e.g., as written, at 542 of FIG. 7A), to the mainframe reservation system 68. The customer may also retrieve, at 676, information from that reservation transaction from the mainframe 66, at 678, for purposes of displaying, modifying or canceling the reservation, or converting the same to a rental. In this example, however, the customer makes no change to the reservation transaction, which was written at 674. Also, in this example, the customer does not select the “Accept” button 480 of FIG. 6K and, hence, does not accept the rental agreement under the terms and conditions 479.

In turn, on the selected pick-up date, the customer travels to the selected rental facility 680 and goes to a kiosk 682 associated therewith. At 684, the customer enters a suitable user identification (e.g., a driver's license number and name; swipes a credit card) which is sent, at 686, to the mainframe 66. In turn, the reservation information is retrieved by the mainframe 66; is sent, at 690, to the kiosk 682; and is displayed, at 692, to the customer. Then, the customer (after entering any remaining rental-related information and reviewing the terms and conditions) presses an “Accept” button 694 at the kiosk 682. In response, the kiosk 682 sends, at 696, this information to the mainframe 66, which responsively sends a rental transaction to the mainframe rental system 70. The exemplary “Accept” button 694 is, thus, the customer's electronic acceptance of the rental proposal. The rental system 70, in turn, stores the rental transaction with the corresponding previously stored reservation transaction in the database 646 (FIG. 8). Preferably, the mainframe 66 sends, at 698, a print stream to a printer (not shown) of the kiosk 682 in order to provide the customer with a rental receipt and/or a summary of the electronically accepted rental agreement, along with directions to obtain the allocated rental vehicle at the rental facility 680.

The exemplary method disclosed herein allows a rental customer to provide information earlier in the reservation and rental process and, thereby, save time, without having to complete a master rental agreement or join a car rental club (e.g., Quicksilver®). The present method provides substantial improvements in the completion of electronic rental agreements. For example, a user need not employ a master rental agreement or a user profile from any other source(s) in order to complete an online reservation and rental of a vehicle. Furthermore, such a user having a master rental agreement (or other user profile) for business (or other) purposes may still employ some of the user profile information from that master rental agreement, and modify some of that profile information for a personal vehicle rental, without modifying the business-related master rental agreement. Accordingly, the user, such as a business traveler or a person on vacation, may complete an electronic rental agreement, and save precious business or vacation time.

The exemplary method stores an electronic rental agreement and accesses historical rental records, including the exemplary selected (e.g., ADD) and declined (e.g., DECLINE) options and an electronic signature, which shows approval of the entire electronic rental agreement. This is accomplished without requiring a printed and hand-signed physical rental agreement. By employing an electronic signature in the exemplary online rental process, the storage and retrieval of the electronic rental agreement and rental-related information is accomplished without printing, hand initialing, hand signing and scanning a physical rental agreement document.

While for clarity of disclosure reference has been made herein to the exemplary PC 26 and kiosk 682 for displaying reservation-related and/or rental-related information, rental proposals and rental agreements, it will be appreciated that such information may be stored, printed on hard copy, be computer modified, be combined with other data, or be transmitted for display elsewhere. All such processing shall be deemed to fall within the terms “display” or “displaying” as employed herein.

Although the exemplary frame relay protocol 44 and ATM protocol 50 have been disclosed herein, the invention is applicable to any suitable communication protocol, such as, for example, TCP/IP, UDP/IP, SNA, XML, and WAP.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A method of creating and storing an electronic rental contract for a rental vehicle from a rental car company to permit a user to bypass a rental counter of a car rental facility when creating the electronic rental contract, the method comprising:
hosting a website on a server system, the website comprising a plurality of web pages for access over a network by any of a plurality of client systems;
creating a rental vehicle reservation in response to data received through the website from a client system;
storing a reservation transaction within the server system, wherein the reservation transaction is representative of the created rental vehicle reservation;
electronically accepting additional data from a user for a potential rental of a rental vehicle based on the rental vehicle reservation;
communicating an electronic rental proposal for display to the user, the electronic rental proposal being based on the rental vehicle reservation and the accepted additional data;
creating an electronic rental contract for a rental vehicle in response to an electronic acceptance by the user of the electronic rental proposal, thereby resulting in the user bypassing the rental counter when creating the electronic rental contract; and
storing a rental transaction within the server system, wherein the rental transaction is representative of the created electronic rental contract; and
wherein the electronically accepting, communicating, electronic rental contract creating and rental transaction storing steps are performed regardless of whether the user has a pre-existing master rental agreement with the rental car company.

2. The method of claim 1 wherein the electronically accepting, communicating, electronic rental contract creating and rental transaction storing steps are performed for a user who does not have a pre-existing master rental agreement with the rental car company.

3. The method of claim 2 further comprising:
allocating a rental vehicle to the user at the car rental facility in accordance with the electronic rental contract without requiring the user to visit the rental counter.

4. The method of claim 2 wherein the rental transaction comprises a data flag which identifies the rental transaction as being associated with an electronic rental contract, the data flag identifying that the user need not visit the rental counter to create a rental contract when arriving at the car rental facility to pick up a rental vehicle in accordance with the electronic rental contract.

5. The method of claim 4 wherein the rental transaction further comprises a plurality of additional data flags for identifying whether a plurality of different rental options were accepted as part of the electronic rental contract.

6. The method of claim 2 wherein the communicating step comprises communicating the electronic rental proposal for display to the user on an automated kiosk located in the car rental facility, and wherein the electronic rental contract creating step comprises receiving the electronic acceptance from the user through the kiosk.

7. The method of claim 6 wherein the electronically accepting step comprises electronically accepting the additional data from the user through the kiosk.

8. The method of claim 7 wherein the additional data comprises driver's license information for the user and credit card payment information for the user, the method further comprising:
electronically performing a first validation operation on the driver's license information such that the communicating step is not performed should the first validation operation indicate the driver's license information is invalid;
should the first validation operation indicate the driver's license information is invalid, electronically requesting that the user re-submit new driver's license information;
electronically performing a second validation operation on the credit card payment information such that the communicating step is not performed should the second validation operation indicate the credit card payment information is invalid; and
should the second validation operation indicate the credit card payment information is invalid, electronically requesting that the user re-submit new credit card payment information.

9. The method of claim 7 wherein the electronically accepting step further comprises receiving identification information for the user at the kiosk, the method further comprising:
retrieving the stored reservation transaction in response to the received user identification information; and
providing information about the retrieved reservation transaction to the kiosk for display thereon.

10. The method of claim 9 further comprising:
electronically soliciting the additional data from the user through the kiosk.

11. The method of claim 9 wherein the user identification information receiving step comprises receiving a driver's license number from the user through the kiosk.

12. The method of claim 9 wherein the user identification information receiving step comprises receiving credit card information from the user following a swipe at the kiosk of a credit card by the user.

13. The method of claim 9 wherein the kiosk comprises a printer, the method further comprising:
delivering a print stream to the printer for printing a receipt and summary for the created electronic rental contract.

14. The method of claim 13 wherein the print stream includes data for printing directions for the user to obtain a rental vehicle at the car rental facility in accordance with the created electronic rental contract.

15. The method of claim 7 wherein the additional data comprises a modification of a data item from the reservation.

16. The method of claim 2 further comprising:
storing the reservation transaction and the rental transaction together in a database as a unique reservation and rental transaction.

17. The method of claim 2 wherein the additional data comprises driver's license information for the user, the method further comprising:
electronically performing a validation operation on the driver's license information such that the communicating step is not performed should the validation operation indicate the driver's license information is invalid; and
should the validation operation indicate the driver's license information is invalid, electronically requesting that the user re-submit new driver's license information.

18. The method of claim 17 wherein the driver's license information comprises an identification of a state for a driver's license and a plurality of digits that are representative of a driver's license number, wherein the validation operation performing step comprises electronically checking whether the driver's license number digits conform to a valid digit pattern for the state corresponding to the state identification.

19. The method of claim 2 wherein the additional data comprises credit card payment information for the user, the method further comprising:
electronically performing a validation operation on the credit card payment information such that the communicating step is not performed should the validation operation indicate the credit card payment information is invalid; and
should the validation operation indicate the credit card payment information is invalid, electronically requesting that the user re-submit new credit card payment information.

20. The method of claim 19 wherein the credit card payment information comprises a credit card number and name of a credit card holder, wherein the validation operation performing step comprises electronically checking whether the credit card holder's name matches a name for a primary driver with respect to the potential rental.

21. The method of claim 2 wherein the additional data comprises driver's license information for the user and credit card payment information for the user, the method further comprising:
electronically performing a first validation operation on the driver's license information such that the communicating step is not performed should the first validation operation indicate the driver's license information is invalid;
should the first validation operation indicate the driver's license information is invalid, electronically requesting that the user re-submit new driver's license information;
electronically performing a second validation operation on the credit card payment information such that the communicating step is not performed should the second validation operation indicate the credit card payment information is invalid; and
should the second validation operation indicate the credit card payment information is invalid, electronically requesting that the user re-submit new credit card payment information.

22. The method of claim 2 wherein the additional data comprises a modification of a data item from the reservation.

23. The method of claim 1 further comprising:
after the reservation creating step, electronically receiving input from the user indicative of a request to convert the created reservation into an electronic rental contract; and
responsive to the received input, providing a first web page of the website to a client system for display thereon, wherein the first web page is configured to solicit the additional data from the user.

24. The method of claim 23 further comprising:
after the reservation creating step, providing a second web page of the website to the client system for display thereon, wherein the second web page is configured to provide the user with a user-selectable option to only create the reservation and a user-selectable option to convert the created reservation into an electronic rental contract; and
wherein the input receiving step comprises receiving a user selection of the option to convert the created reservation into an electronic rental contract, thereby advancing the user to the first web page.

25. The method of claim 23 further comprising:
after the reservation creating step, sending an email to the user, wherein the email comprises (1) a confirmation of the created reservation, and (2) a user-selectable link that is effective upon user selection to link the user to the first web page; and
wherein the input receiving step comprises receiving a user selection of the link.

26. The method of claim 23 further comprising:
automatically pre-filling at least a portion of the additional data into a web page of the website from a rental history associated with the user.

27. The method of claim 26 further comprising:
receiving a selection by the user of a button on the web page; and
responsive to the button selection, performing the pre-filling step.

28. The method of claim 23 further comprising:
automatically performing a suggestive sell for the potential rental through a web page of the website based on a rental history associated with the user.

29. The method of claim 28 wherein the suggestive sell is for an optional coverage item for the potential rental.

30. The method of claim 1 further comprising:
for a user who has a pre-existing master rental agreement with the rental car company, (1) providing a first web page of the website to a client system for display thereon, wherein the first web page is configured to solicit the data for creating the reservation from the user, and (2) automatically pre-filling at least a portion of the data for creating the reservation into the first web page from the master rental agreement.

31. The method of claim 30 further comprising:
permitting the user to electronically modify the pre-filled data without modifying the master rental agreement.

32. The method of claim 31 further comprising:
receiving a modification of the pre-filled data from the user through the website; and
electronically notifying the user with a selectable option to keep the modification and a selectable option to revert to the pre-filled data.

33. The method of claim 32 wherein the pre-filled data does not include credit card information from the master rental agreement.

34. The method of claim 1 wherein the server system is operated by the rental car company.

35. A system for creating and storing an electronic rental contract for a rental vehicle from a rental car company to permit a user to bypass a rental counter of a car rental facility when creating the electronic rental contract, the system comprising a server system configured to:
host a website, the website comprising a plurality of web pages for access over a network by any of a plurality of client systems;
create a rental vehicle reservation in response to data received through the website from a client system;
store a reservation transaction, wherein the reservation transaction is representative of the created rental vehicle reservation;
accept additional data from a user for a potential rental of a rental vehicle based on the rental vehicle reservation;
communicate an electronic rental proposal for display to the user, the electronic rental proposal being based on the rental vehicle reservation and the accepted additional data;
create an electronic rental contract for a rental vehicle in response to an electronic acceptance by the user of the electronic rental proposal, thereby resulting in the user being able to bypass the rental counter when creating the electronic rental contract; and
store a rental transaction, wherein the rental transaction is representative of the created electronic rental contract; and
wherein the server system is further configured to perform the additional data acceptance, the communication, the electronic rental contract creation and the rental transaction storage regardless of whether the user has a pre-existing master rental agreement with the rental car company.

36. The system of claim 35 wherein the server system is further configured to perform the additional data acceptance, the communication, the electronic rental contract creation and the rental transaction storage for a user who does not have a pre-existing master rental agreement with the rental car company.

37. The system of claim 36 wherein the rental transaction comprises a data flag which identifies the rental transaction as being associated with an electronic rental contract, the data flag identifying that the user need not visit the rental counter to create a rental contract when arriving at the car rental facility to pick up a rental vehicle in accordance with the electronic rental contract.

38. The system of claim 37 wherein the rental transaction further comprises a plurality of additional data flags for identifying whether a plurality of different rental options were accepted as part of the electronic rental contract.

39. The system of claim 36 wherein the server system comprises a server subsystem and an automated kiosk located in the car rental facility, the kiosk in communication with the server subsystem, wherein the server subsystem is configured to communicate the electronic rental proposal to the kiosk for display thereon to the user, and wherein the kiosk is configured to receive the electronic acceptance of the electronic rental proposal from the user.

40. The system of claim 39 wherein the kiosk is further configured to accept the additional data from the user.

41. The system of claim 40 wherein the additional data comprises driver's license information for the user and credit card payment information for the user, and wherein the server system is further configured to:
perform a first validation operation on the driver's license information such that the electronic rental proposal communication is not performed should the first validation operation indicate the driver's license information is invalid;
should the first validation operation indicate the driver's license information is invalid, electronically request that the user re-submit new driver's license information;
perform a second validation operation on the credit card payment information such that the electronic rental proposal communication is not performed should the second validation operation indicate the credit card payment information is invalid; and
should the second validation operation indicate the credit card payment information is invalid, request that the user re-submit new credit card payment information.

42. The system of claim 41 wherein the kiosk is further configured to receive identification information for the user, and wherein the server subsystem is further configured to:
retrieve the stored reservation transaction in response to the received user identification information; and
provide information about the retrieved reservation transaction to the kiosk for display thereon.

43. The system of claim 42 wherein the kiosk is further configured to electronically solicit the additional data from the user.

44. The system of claim 42 wherein the kiosk is further configured to receive a driver's license number from the user as the user identification information.

45. The system of claim 42 wherein the kiosk is further configured to receive credit card information from the user as the user identification information following a swipe at the kiosk of a credit card by the user.

46. The system of claim 42 wherein the kiosk comprises a printer, and wherein the server subsystem is further configured to deliver a print stream to the printer for printing a receipt and summary for the created electronic rental contract.

47. The system of claim 46 wherein the print stream includes data for printing directions for the user to obtain a rental vehicle at the car rental facility in accordance with the created electronic rental contract.

48. The system of claim 40 wherein the additional data comprises a modification of a data item from the reservation.

49. The system of claim 36 wherein the server system further comprises a database, and wherein the server system is further configured to store the reservation transaction and the rental transaction together in the database as a unique reservation and rental transaction.

50. The system of claim 36 wherein the additional data comprises driver's license information for the user, and wherein the server system is further configured to:
perform a validation operation on the driver's license information such that the electronic rental proposal communication is not performed should the validation operation indicate the driver's license information is invalid; and
should the validation operation indicate the driver's license information is invalid, electronically request that the user re-submit new driver's license information.

51. The system of claim 50 wherein the driver's license information comprises an identification of a state for a driver's license and a plurality of digits that are representative of a driver's license number, and wherein the server system is further configured to perform the validation operation by checking whether the driver's license number digits conform to a valid digit pattern for the state corresponding to the state identification.

52. The system of claim 36 wherein the additional data comprises credit card payment information for the user, and wherein the server system is further configured to:
perform a validation operation on the credit card payment information such that the electronic rental proposal communication is not performed should the validation operation indicate the credit card payment information is invalid; and
should the validation operation indicate the credit card payment information is invalid, electronically request that the user re-submit new credit card payment information.

53. The system of claim 52 wherein the credit card payment information comprises a credit card number and name of a credit card holder, and wherein the server system is further configured to perform the validation operation by checking whether the credit card holder's name matches a name for a primary driver with respect to the potential rental.

54. The system of claim 36 wherein the additional data comprises driver's license information for the user and credit card payment information for the user, and wherein the server system is further configured to:
perform a first validation operation on the driver's license information such that the electronic rental proposal communication is not performed should the first validation operation indicate the driver's license information is invalid;
should the first validation operation indicate the driver's license information is invalid, electronically request that the user re-submit new driver's license information;
perform a second validation operation on the credit card payment information such that the electronic rental proposal communication is not performed should the second validation operation indicate the credit card payment information is invalid; and
should the second validation operation indicate the credit card payment information is invalid, electronically request that the user re-submit new credit card payment information.

55. The system of claim 36 wherein the additional data comprises a modification of a data item from the reservation.

56. The system of claim 35 wherein the server system is further configured to:
after the reservation creation, receive input from the user indicative of a request to convert the created reservation into an electronic rental contract; and
responsive to the received input, provide a first web page of the website to a client system for display thereon, wherein the first web page is configured to solicit the additional data from the user.

57. The system of claim 56 wherein the server system is further configured to:
after the reservation creation, provide a second web page of the website to the client system for display thereon, wherein the second web page is configured to provide the user with a user-selectable option to only create the reservation and a user-selectable option to convert the created reservation into an electronic rental contract; and
receive a user selection of the option to convert the created reservation into an electronic rental contract for thereby advancing the user to the first web page.

58. The system of claim 56 wherein the server system is further configured to:
after the reservation creation, send an email to the user, wherein the email comprises (1) a confirmation of the created reservation, and (2) a user-selectable link that is effective upon user selection to link the user to the first web page; and
receive a user selection of the link.

59. The system of claim 56 wherein the server system is further configured to automatically pre-fill at least a portion of the additional data into a web page of the website from a rental history associated with the user.

60. The system of claim 59 wherein the server system is further configured to:
receive a selection by the user of a button on the web page; and
responsive to the button selection, perform the automatic pre-fill.

61. The system of claim 56 wherein the server system is further configured to automatically perform a suggestive sell for the potential rental through a web page of the website based on a rental history associated with the user.

62. The system of claim 61 wherein the suggestive sell is for an optional coverage item for the potential rental.

63. The system of claim 35 wherein the server system is further configured to:
for a user who has a pre-existing master rental agreement with the rental car company, (1) provide a first web page of the website to a client system for display thereon, wherein the first web page is configured to solicit the data for creating the reservation from the user, and (2) automatically pre-fill at least a portion of the data for creating the reservation into the first web page from the master rental agreement.

64. The system of claim 63 wherein the server system is further configured to:
permit the user to electronically modify the pre-filled data without modifying the master rental agreement.

65. The system of claim 64 wherein the server system is further configured to:
receive a modification of the pre-filled data from the user through the website; and
notify the user with a selectable option to keep the modification and a selectable option to revert to the pre-filled data.

66. The system of claim 65 wherein the pre-filled data does not include credit card information from the master rental agreement.

67. A system for creating and storing an electronic rental contract for a rental vehicle such that a user need not visit a rental counter to create a rental contract when arriving at a car rental facility to pick up the rental vehicle, the system comprising:
a server subsystem;
a kiosk in communication with the server subsystem;
wherein the server subsystem is configured to host a website, the website comprising a plurality of web pages for access over a network by any of a plurality of client systems;
wherein the server subsystem is further configured to interact with a client system over the network and through the website to create a rental vehicle reservation;
wherein the server subsystem is further configured to provide a first path and a second path for a user to convert a rental vehicle reservation into an electronic rental contract for a rental vehicle, the first path being a path through the website and the second path being a path through the kiosk;
wherein the website is configured to permit a user of the client system to convert a rental vehicle reservation into an electronic rental contract for a rental vehicle via a plurality of web pages within a rental path of the website;
wherein the server subsystem is further configured to provide the user with a plurality of options for entering the website's rental path, the plurality of options comprising an entry into the website's rental path immediately after creating a rental vehicle reservation and an entry into the website's rental path during a subsequent visit to the website after creating a rental vehicle reservation;
wherein the kiosk is configured to permit the user to convert a rental vehicle reservation into an electronic rental contract for a rental vehicle via user interaction with the kiosk;
wherein the server subsystem is further configured to create an electronic rental contract for a rental vehicle from a rental vehicle reservation in response to data input from any of the first and second paths; and
wherein the electronic rental contract permits the user to avoid creating a rental contract at the rental counter when arriving at the car rental facility to pick up a rental vehicle in accordance with the electronic rental contract.

68. The system of claim 67 wherein the server subsystem is further configured to create the electronic rental contract regardless of whether the user has a pre-existing master rental agreement with a rental car company.

69. The system of claim 68 wherein the server subsystem is further configured to create the electronic rental contract for a user who does not have a pre-existing master rental agreement with the rental car company.

70. The system of claim 68 wherein the server subsystem comprises a web server, a database, and a mainframe, wherein the web server is configured to host the website, wherein the database is configured to store data representative of the rental vehicle reservation and the electronic rental contract, and wherein the mainframe is configured to (1) execute reservation component software to create the rental vehicle reservation in response to data input from the client system through the website, and (2) execute rental component software to create the electronic rental contract in response to the data input from any of the first and second paths.

71. A method of creating an electronic rental contract for a rental vehicle from a rental car company such that a user need not visit a rental counter to create a rental contract when arriving at a car rental facility to pick up the rental vehicle, the method comprising:
storing data representative of a rental vehicle reservation, the stored data comprising data that associates the reservation with a user who does not have a pre-existing master rental agreement with the rental car company;
receiving, through an automated kiosk located at a car rental facility, identification information for the user;
retrieving the stored reservation data that is associated with the received user identification information;
displaying, through the kiosk, an electronic rental proposal based on the retrieved reservation data;
receiving, from the user through the kiosk, an electronic acceptance of the displayed rental proposal to thereby create an electronic rental contract, the electronic rental contract permitting the user to avoid creating a rental contract at the rental counter when arriving at the car rental facility to pick up a rental vehicle in accordance with the electronic rental contract; and
storing data representative of the created electronic rental contract.

72. The method of claim 71 further comprising:
allocating a rental vehicle to the user at the car rental facility in accordance with the electronic rental contract without requiring the user to visit the rental counter.

73. The method of claim 71 further comprising:
receiving, from the user through the kiosk, supplemental data for a potential rental based on the reservation; and
creating the electronic rental proposal based on the received supplemental data and the retrieved reservation data.

74. The method of claim 73 wherein the received supplemental data comprises a modification of a data item from the reservation.
